(19) United States
(12) Patent Application Publication
(10) Pub. No.: US 2022/0241962 A1
(43) Pub. Date: Aug. 4, 2022

(54) END EFFECTOR TOOL CHANGER FOR PICK AND PLACE ROBOTIC SYSTEMS

(71) Applicant: XYZ Robotics Global Inc., Grand Cayman (KY)

(72) Inventors: Thanh Nha Nguyen, Somerville, MA (US); Kuan-Ting Yu, Natick, MA (US)

(21) Appl. No.: 17/721,770

(22) Filed: Apr. 15, 2022

Related U.S. Application Data
(63) Continuation of application No. PCT/US20/57146, filed on Oct. 23, 2020.
(60) Provisional application No. 62/925,219, filed on Oct. 23, 2019.

(51) Int. Cl. B25J 9/16; B25J 15/04; B25J 13/08

(52) U.S. Cl. CPC B25J 9/163; B25J 15/0491; B25J 15/0441; B25J 9/1697; B25J 19/00; B25J 13/085; B25J 9/1612; G05B 2219/39001; G05B 2219/45063; B25J 13/082

(57) ABSTRACT

End effector tool changers for a pick, sort, and place robotic system are disclosed. The end effector tool changer comprises an arm attachment portion, a plurality of engagement mechanisms, wherein each engagement mechanism comprises a first part and a second part, and wherein the first part and the second part of the engagement mechanism are selected from the group consisting of a pin and a pinhole; a robotic arm attachment portion, comprising a first plurality of magnets and a first plurality of first parts of the plurality of engagement mechanisms; and a tool attachment portion, comprising a second plurality of magnets and a second plurality of second parts of the plurality of engagement mechanisms. The end effector tool changer has greater mechanical stability, prevents accidental disconnection of the tool, and prevents unintentional rotation of the tool.

### FIELD OF THE INVENTION

Embodiments of the present invention are in the field of robotic systems that use artificial intelligence, computer vision, and/or mechanical systems to pick, sort, and place objects, and pertain particularly to tool changers for a pick, sort, and place robotic system.

### BACKGROUND OF THE INVENTION

The statements in the background of the invention are provided to assist with understanding the invention and its applications and uses, and may not constitute prior art.

There are several approaches that have been used to change end effector tools for a sort and place robotic system to pick objects of varying dimensions, weights, materials, and levels of fragility. However, many of these approaches either require human intervention, are too slow, do not retain the new tool firmly, or are unreliable. For example, some conventional tool changers have two or more magnets that are magnetized and are axially symmetric. Such a tool changer has a low radial strength, and the tool portion can become unintentionally disconnected from the robotic arm portion with even a minor transverse force. Such a tool changer can also easily rotate, even when such rotation is undesired, and there is no control over the axial rotation.

Therefore, it would be an advancement in the state of the art to provide an end effector tool changer for a pick, sort, and place robotic system that is mechanically robust, has high radial strength, prevents undesirable rotations, uses minimal sensory input, is suitable for a wide variety of tools, and operates quickly.

It is against this background that the present invention was developed.

### BRIEF SUMMARY OF THE INVENTION

The present invention relates to an end effector tool changer for a pick, sort, and place robotic system.

More specifically, in various embodiments, the present invention is an end effector tool changer device for a pick and place robotic system, comprising a robotic arm with an end effector configured to have an attached tool at its distal end; a tool changing device comprising a robotic arm attachment portion and a tool attachment portion; a tool rack comprising one or more tool plates and a plurality of tools; a vision system; and a control system comprising a processor, a non-transitory computer readable storage medium, and a plurality of communication interfaces; wherein the end effector comprises a robotic arm attachment portion of the tool changing device at its distal end, at least one tool comprises a tool attachment portion of the tool changing device at its proximal end, the robotic arm attachment portion is configured to attach to the tool attachment portion, at least one tool plate of the one or more tool plates comprises a tool slot, the pick and place robotic system is configured to load a tool from the tool rack to the end effector, and the pick and place robotic system is configured to unload a tool from the end effector to the tool rack.

In some embodiments, the tool changing device comprises a plurality of engagement mechanisms, wherein each engagement mechanism comprises a first part and a second part, wherein the first part and the second part of the engagement mechanism are selected from the group consisting of a pin and a pinhole, and wherein at least one of the first part and the second part is a pin, wherein the robotic arm attachment portion comprises a first plurality of magnets and a first plurality of first parts of the plurality of engagement mechanisms, wherein the tool attachment portion comprises a second plurality of magnets and a second plurality of second parts of the plurality of engagement mechanisms, wherein the first plurality of magnets spatially and magnetically corresponds to the second plurality of magnets, and wherein the first plurality of first parts of the plurality of engagement mechanisms spatially corresponds to the second plurality of second parts of the plurality of engagement mechanisms.

In some embodiments, the tool attachment portion further comprises a plurality of grooves, and the plurality of grooves spatially corresponds to a tool slot on a tool plate.

In some embodiments, the tool rack further comprises one or more sensors associated with a tool slot, wherein the one or more sensors are configured to indicate the presence of a tool in the tool slot.

In some embodiments, the pick and place robotic system further comprises a weight sensor at the distal end of the end effector, wherein the weight sensor is configured to measure the weight of a tool and a load of the tool.

In some embodiments, the pick and place robotic system further comprises an electric circuit, wherein the electric circuit is configured to indicate the presence of a tool attached to the end effector.

In some embodiments, the pick and place robotic system further comprises a plurality of input and output components, wherein at least one output component corresponds to an object type, and the plurality of input and output components are selected from the group consisting of a sorting stand, a tote, a receptacle stand, a bin, a tote conveyor, an object conveyor, a put wall, an automated guided vehicle (AGV), and a shelf.

In some embodiments, the robotic arm and tool attachment portions further comprise a through-hole.

In some embodiments, the pick and place robotic system further comprises a first hose, wherein the through-hole of the robotic arm attachment portion is connected to a distal end of the first hose.

In some embodiments, the pick and place robotic system further comprises a pressure sensor, wherein the pressure sensor is located on the first hose.

In some embodiments, the pick and place robotic system further comprises a source pump, wherein the source pump is connected to the proximal end of the first hose, and the source pump is selected from the group consisting of a vacuum pump and a compressed air pump.

In some embodiments, the pick and place robotic system further comprises a valve and one or more second hoses, wherein the valve connects the proximal end of the first hose to one valve output selected from the group consisting of the atmosphere and the one or more second hoses.

In some embodiments, the pick and place robotic system further comprises one or more source pumps, wherein at least one of the one or more second hoses connects a valve output to one of the one or more source pumps, at least one tool of the plurality of tools corresponds to one of the one or more source pumps, and a source pump of the one or more source pumps is selected form the group consisting of a vacuum pump and a compressed air pump.

In some embodiments, the vision system comprises a vision processor, a plurality of vision communication interfaces, and one or more vision components selected from the group consisting of a camera, a barcode reader, a depth sensor, an infrared sensor, a light curtain system, and a LIDAR; and wherein at least one component of the vision system is connected to the vision processor through a data link, and the vision processor is connected to the control system through a data link.

In some embodiments, the pick and place robotic system further comprises a lighting source, wherein the lighting source is configured to emit multiple light intensities.

In some embodiments, the non-transitory computer readable storage medium has program instructions embodied therein, the program instructions executable by the processor to cause the processor to determine a selected tool to load; move the robotic arm toward the tool rack over the selected tool; lower the robotic arm until a plurality of pins are in a plurality of corresponding pinholes and a plurality of magnets on the arm attachment portion meets a plurality of corresponding magnets on the tool attachment portion; and move the arm away from the tool rack.

In some embodiments, the non-transitory computer readable storage medium has program instructions embodied therein, the program instructions executable by the processor to cause the processor to move the robotic arm toward the tool rack; slide tool attachment portion of the tool at its distal end into a tool plate of the one or more tool plates; move the robotic arm away from the tool plate; and decouple a plurality of magnets on the robotic arm attachment portion from a plurality of corresponding magnets on the tool attachment portion.

In some embodiments, the non-transitory computer readable storage medium has program instructions embodied therein, the program instructions executable by the processor to cause the processor to determine a selected tool to load, determine a corresponding source pump, and connect the corresponding source pump to the first hose using the valve.

In some embodiments, the non-transitory computer readable storage medium has program instructions embodied therein, the program instructions executable by the processor to cause the processor to receive data from the one or more sensors associated with a tool slot, and determine whether a tool is present in the tool slot, based on the data received from the one or more sensors.

In some embodiments, the non-transitory computer readable storage medium has program instructions embodied therein, the program instructions executable by the processor to cause the processor to receive data from the weight sensor, and determine whether a tool is attached to the end effector, based on the data received from the weight sensor.

In some embodiments, the non-transitory computer readable storage medium has program instructions embodied therein, the program instructions executable by the processor to cause the processor to receive data from the weight sensor, and determine that an object grasped by a tool attached at the distal end of the end effector has fallen, based on the data received from the weight sensor.

In some embodiments, the non-transitory computer readable storage medium has program instructions embodied therein, the program instructions executable by the processor to cause the processor to receive data from the weight sensor, and determine that more than one object is grasped by a tool attached at the distal end of the end effector, based on the data received from the weight sensor.

In some embodiments, the non-transitory computer readable storage medium has program instructions embodied therein, the program instructions executable by the processor to cause the processor to receive data from the vision system, and determine that more than one object is grasped by a tool attached at the distal end of the end effector, based on the data received from the vision system.

In some embodiments, the non-transitory computer readable storage medium has program instructions embodied therein, the program instructions executable by the processor to cause the processor to receive data from a tool wire, and determine whether a tool is attached to the end effector, based on the data received from the tool wire.

In some embodiments, the non-transitory computer readable storage medium has program instructions embodied therein, the program instructions executable by the processor to cause the processor to receive data from the vision system, and determine whether a tool is attached to the end effector, based on the data received from the vision system.

In some embodiments, the non-transitory computer readable storage medium has program instructions embodied therein, the program instructions executable by the processor to cause the processor to receive data from the pressure sensor, and determine whether a tool attached to the end effector is damaged, based on the data received from the pressure sensor.

In some embodiments, the non-transitory computer readable storage medium has program instructions embodied therein, the program instructions executable by the processor to cause the processor to receive data from the vision system, determine that a tool at the distal end of the end effector is detached, locate the detached tool, based on the data received from the vision system, determine a picking tool from the plurality of tools for picking the detached tool, based on the shape of the detached tool, load the picking tool to the end effector, pick the detached tool using the picking tool, and slide the tool attachment portion of the detached tool into a tool plate of the tool rack.

In some embodiments, the non-transitory computer readable storage medium has program instructions embodied therein, the program instructions executable by the processor to cause the processor to receive data from the vision system, and determine that an object grasped by a tool attached at the distal end of the end effector has fallen, based on the data received from the vision system.

In some embodiments, the non-transitory computer readable storage medium has program instructions embodied therein, the program instructions executable by the processor to cause the processor to receive data from the pressure sensor, and determine that an object grasped by a tool attached at the distal end of the end effector has fallen, based on the data received from the pressure sensor.

In some embodiments, the non-transitory computer readable storage medium has program instructions embodied therein, the program instructions executable by the processor to cause the processor to receive data from the vision system, and determine a light intensity for the lighting source, based on the data received from the vision system.

In some embodiments, the non-transitory computer readable storage medium has program instructions embodied therein, the program instructions executable by the processor to cause the processor to receive data from the vision system, detect an object to be picked based on the data received from the vision system, and determine one or more picking areas on the surface of the object to be picked.

In some embodiments, the program instructions executable by the processor further cause the processor to estimate a picking score associated with at least one of the one or more picking areas, for at least one of the plurality of tools, based on the data received from the vision system, wherein the picking score indicates a likelihood that the robotic arm successfully picks the object.

In some embodiments, the program instructions executable by the processor further cause the processor to select a tool from the plurality of tools, wherein the selected tool corresponds to the highest picking score.

In some embodiments, the non-transitory computer readable storage medium has program instructions embodied therein, the program instructions executable by the processor to cause the processor to receive data from the vision system, detect one or more objects to be picked, based on the data received from the vision system, and determine an object type for a first object of the one or more objects to be picked.

In some embodiments, the program instructions executable by the processor further cause the processor to select a tool from the plurality of tools based on the determined object type.

In some embodiments, the non-transitory computer readable storage medium has program instructions embodied therein, the program instructions executable by the processor to cause the processor to receive data from the vision system, and determine that a previously placed object was placed in an incorrect output component based on the data received from the vision system; wherein the incorrect output component is an output component that does not correspond to the object type of the previously placed object.

In some embodiments, the program instructions executable by the processor further cause the processor to determine a correct output component, remove the previously placed object from the incorrect output component, and place the previously placed object into the correct output component; wherein the correct output component is an output component that corresponds to the object type of the previously placed object.

In some embodiments, the non-transitory computer readable storage medium has program instructions embodied therein, the program instructions executable by the processor to cause the processor to receive data from the vision system, halt the movement of the robotic arm, based on the data received from the vision system.

In some embodiments, the non-transitory computer readable storage medium has program instructions embodied therein, the program instructions executable by the processor to cause the processor to receive data from the vision system, determine a trajectory of the robotic arm based on the data received from the vision system.

In some embodiments, the non-transitory computer readable storage medium has program instructions embodied therein, the program instructions executable by the processor to cause the processor to load a tool from a tool rack, determine a new status for the tool loaded from the tool rack, and update an entry corresponding to the tool loaded from the tool rack in a tool status table.

In some embodiments, the non-transitory computer readable storage medium has program instructions embodied therein, the program instructions executable by the processor to cause the processor to unload a tool into a tool rack, determine a new status for the tool unloaded into the tool rack, and update an entry corresponding to the tool unloaded into the tool rack in a tool status table.

In some embodiments, the non-transitory computer readable storage medium has program instructions embodied therein, the program instructions executable by the processor to cause the processor to receive data from one or more sensors associated with a tool slot corresponding to a given tool, determine whether a tool is present in the tool slot, based on the sensor data, and update an entry corresponding to the given tool in a tool status table, based on the determination of whether the tool is present in the tool slot.

In some embodiments, the non-transitory computer readable storage medium has program instructions embodied therein, the program instructions executable by the processor to cause the processor to receive data from one or more sensors associated with a tool slot corresponding to a given tool, determine whether a tool is present in the tool slot, based on the sensor data, verify an entry corresponding to the given tool in a tool status table, and generate a tool location error notification, based on the determination of whether the tool is present in the tool slot.

In various embodiments, the present invention is an end effector tool changer device for a pick and place robotic system, comprising a plurality of engagement mechanisms, wherein each engagement mechanism comprises a first part and a second part, wherein the first part and the second part of the engagement mechanism are selected from the group consisting of a pin and a pinhole, and wherein at least one of the first part and the second part is a pin; a robotic arm attachment portion, comprising a first plurality of magnets and a first plurality of first parts of the plurality of engagement mechanisms; and a tool attachment portion, comprising a second plurality of magnets and a second plurality of second parts of the plurality of engagement mechanisms, wherein the first plurality of magnets spatially and magnetically corresponds to the second plurality of magnets, and wherein the first plurality of first parts of the plurality of engagement mechanisms spatially corresponds to the second plurality of second parts of the plurality of engagement mechanisms.

In some embodiments, the pin is selected from the group consisting of an indicator pin and a lateral pin.

In some embodiments, the robotic arm attachment portion and the plurality of first parts of the plurality of engagement mechanisms form a single piece.

In some embodiments, the tool attachment portion and the plurality of second parts of the plurality of engagement mechanisms form a single piece.

In some embodiments, the tool attachment portion further comprises a plurality of grooves.

In some embodiments, one or more of the plurality of grooves are beveled.

In some embodiments, the plurality of grooves is a pair of grooves.

In some embodiments, the distance between a magnet of the first plurality of magnets and a corresponding magnet of the second plurality of magnets when the robotic arm attachment and the tool attachment portions are engaged, was selected to generate a strength of the magnetic force between the magnet of the first plurality of magnets and the corresponding magnet of the second plurality of magnets.

In some embodiments, the volumes of a magnet of the first plurality of magnets and a corresponding magnet of the second plurality of magnets were selected to generate a strength of the magnetic force between the magnet of the first plurality of magnets and the corresponding magnet of the second plurality of magnets.

In some embodiments, the grades of a magnet of the first plurality of magnets and a corresponding magnet of the second plurality of magnets were selected to generate a strength of the magnetic force between the magnet of the first plurality of magnets and the corresponding magnet of the second plurality of magnets.

In some embodiments, the end effector tool changer device further comprises a tool plate, the tool plate comprising a slot, wherein the dimensions of the slot correspond to the plurality of grooves.

In some embodiments, the slot is tapered.

In some embodiments, the robotic arm and tool attachment portions each further comprise a through-hole.

In some embodiments, the through-hole in the robotic arm attachment portion is adjacent to an O-ring.

In some embodiments, an engagement mechanism of the plurality of engagement mechanisms comprises a pin with a tapered tip.

In some embodiments, an engagement mechanism of the plurality of engagement mechanisms comprises a beveled pinhole.

Other aspects and embodiments of the present invention include the methods and processes comprising the steps described herein, and also include the processes and modes of operation of the systems and devices described herein.

Yet other aspects and embodiments of the present invention will become apparent from the detailed description of the invention when read in conjunction with the attached drawings.

### BRIEF DESCRIPTION OF THE DRAWINGS

Embodiments of the present invention described herein are exemplary, and not restrictive. Embodiments will now be described, by way of examples, with reference to the accompanying drawings, in which:

FIGS. 1A, 1B, and 1C show exemplary pick, sort, and place robotic systems in accordance with some embodiments.

FIG. 2A shows an isometric view of an example arm attachment portion of an end effector tool changer for a pick, sort, and place robotic system, in accordance with one embodiment of the invention.

FIG. 2B shows an isometric view of an example tool attachment portion of an end effector tool changer for a pick, sort, and place robotic system, in accordance with one embodiment of the invention.

FIG. 2C shows a top view from the contact side of an example arm attachment portion of an end effector tool changer for a pick, sort, and place robotic system, in accordance with one embodiment of the invention.

FIG. 2D shows a top view from the contact side of an example tool attachment portion of an end effector tool changer for a pick, sort, and place robotic system, in accordance with one embodiment of the invention.

FIG. 2E shows a top view of an example tool plate for a pick, sort, and place robotic system, in accordance with one embodiment of the invention.

FIG. 3A shows an example end effector tool changer for a pick, sort, and place robotic system, in accordance with one embodiment of the invention.

FIG. 3B shows an isometric view of an example tool attachment portion of an end effector tool changer for a pick, sort, and place robotic system, in accordance with one embodiment of the invention.

FIG. 3C shows an example end effector tool changer for a pick, sort, and place robotic system, in accordance with one embodiment of the invention.

FIGS. 3D, 3E, and 3F show example end effector tool changers with exemplary dimensions for a pick, sort, and place robotic system, in accordance with one embodiment of the invention.

FIGS. 4A, 4B, 4C, 4D, 4E, 4F, 4G, 4H, and 4J show example components of an end effector tool changer for a pick, sort, and place robotic system, in accordance with one embodiment of the invention.

FIG. 4K shows an exploded view of various example components of an end effector tool changer for a pick, sort, and place robotic system, in accordance with one embodiment of the invention.

FIG. 5 shows an example end effector tool changer for a pick, sort, and place robotic system, in accordance with one embodiment of the invention.

FIGS. 6A, 6B, 6C, 6D, 6E, and 6F show various example states of an end effector tool changer for a pick, sort, and place robotic system, in accordance with one embodiment of the invention.

FIG. 7 shows an example state flow for tool retrieval for an end effector tool changer for a pick, sort, and place robotic system, in accordance with one embodiment of the invention.

FIG. 8 shows an example state flow for tool storage for an end effector tool changer for a pick, sort, and place robotic system, in accordance with one embodiment of the invention.

FIG. 9 shows an example state flow for tool switching for an end effector tool changer for a pick, sort, and place robotic system, in accordance with one embodiment of the invention.

FIG. 10 shows an illustrative flow diagram for loading an end effector tool for a pick, sort, and place robotic system, in accordance with one embodiment of the invention.

FIG. 11 shows an illustrative flow diagram for unloading an end effector tool for a pick, sort, and place robotic system, in accordance with one embodiment of the invention.

FIG. 12 shows an illustrative flow diagram for connecting a source pump corresponding to an end effector tool for a pick, sort, and place robotic system, in accordance with one embodiment of the invention.

FIG. 13 shows an illustrative flow diagram for determining whether an end effector tool is present at a given tool slot on the tool rack using the tool sensors, in accordance with one embodiment of the invention.

FIG. 14A shows an illustrative flow diagram for determining whether a tool is present at the end effector using a weight sensor, for a pick, sort, and place robotic system, in accordance with one embodiment of the invention.

FIG. 14B shows an illustrative flow diagram for determining whether a tool is present at the end effector using a vision system, for a pick, sort, and place robotic system, in accordance with one embodiment of the invention.

FIG. 14C shows an illustrative flow diagram for determining whether a tool is present at the end effector using a tool wire, for a pick, sort, and place robotic system, in accordance with one embodiment of the invention.

FIG. 14D shows an illustrative flow diagram for determining whether an attached tool is damaged using a pressure sensor, for a pick, sort, and place robotic system, in accordance with one embodiment of the invention.

FIG. 15A shows an illustrative flow diagram for a pick, sort, and place robotic system to detect, using a weight sensor, that an object grasped by an attached tool has fallen, in accordance with one embodiment of the invention.

FIG. 15B shows an illustrative flow diagram for a pick, sort, and place robotic system to detect, using a weight sensor, that more than one object is grasped by an attached tool, in accordance with one embodiment of the invention.

FIG. 15C shows an illustrative flow diagram for a pick, sort, and place robotic system to detect, using a vision system, that more than one object is grasped by an attached tool, in accordance with one embodiment of the invention.

FIG. 16 shows an illustrative flow diagram for replacing a detached tool into the tool rack of a pick, sort, and place robotic system, in accordance with one embodiment of the invention.

FIG. 17 shows an illustrative flow diagram for adjusting the lighting intensity to improve object or tool vision for a pick, sort, and place robotic system, in accordance with one embodiment of the invention.

FIG. 18 shows an illustrative flow diagram for a pick, sort, and place robotic system to select a tool to pick an object, in accordance with one embodiment of the invention.

FIG. 19 shows an illustrative flow diagram for a pick, sort, and place robotic system to select a next tool based on detected object types, in accordance with one embodiment of the invention.

FIG. 20 shows an illustrative flow diagram for a pick, sort, and place robotic system to replace an object previously placed in an incorrect output component, in accordance with one embodiment of the invention.

FIG. 21 shows an illustrative flow diagram for a pick, sort, and place robotic system to detect an object fall using a vision system, in accordance with one embodiment of the invention.

FIG. 22 shows an illustrative flow diagram for a pick, sort, and place robotic system to detect an object fall using a pressure sensor, in accordance with one embodiment of the invention.

FIG. 23 shows an illustrative flow diagram for a pick, sort, and place robotic system to halt the movement of a robotic arm based on input from the vision system, in accordance with one embodiment of the invention.

FIG. 24 shows an illustrative flow diagram for a pick, sort, and place robotic system to determine a trajectory of the robotic arm based on data received from the vision system, in accordance with one embodiment of the invention.

FIG. 25A shows an illustrative flow diagram for a pick, sort, and place robotic system to update a tool status table following a loading operation, in accordance with one embodiment of the invention.

FIG. 25B shows an illustrative flow diagram for a pick, sort, and place robotic system to update a tool status table following an unloading operation, in accordance with one embodiment of the invention.

FIG. 25C shows an illustrative flow diagram for a pick, sort, and place robotic system to update a tool status table based on sensor data, in accordance with one embodiment of the invention.

FIG. 25D shows an illustrative flow diagram for a pick, sort, and place robotic system to verify a tool status table and generate a notification based on sensor data, in accordance with one embodiment of the invention.

FIG. 26 provides a schematic of a server (management computing entity) according to one

FIG. 27 provides an illustrative schematic representative of a client (user computing entity) that can be used in conjunction with embodiments of the present disclosure.

### DETAILED DESCRIPTION OF THE INVENTION

### Overview

With reference to the figures provided, embodiments of the present invention are now described in detail.

In the following description, for purposes of explanation, numerous specific details are set forth in order to provide a thorough understanding of the invention. It will be apparent, however, to one skilled in the art that the invention can be practiced without these specific details. In other instances, structures, devices, activities, and methods are shown using schematics, use cases, and/or flow diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

There are several approaches that have been used to change end effector tools for a sort and place robotic system to pick objects of varying dimensions, weights, materials, and levels of fragility. However, many of these approaches either require human intervention, are too slow, do not retain the new tool firmly, or are unreliable. For example, some conventional tool changers have two or more magnets that are magnetized and are axially symmetric. Such a tool changer has a low radial strength, and the tool changer can become unintentionally disconnected from the robotic arm with even a minor transverse force. Such a tool changer can also easily rotate, even when such rotation is undesired, and there is no control over the axial rotation.

Therefore, it would be an advancement in the state of the art to provide an end effector tool changer for a pick, sort, and place robotic system that is mechanically robust, has high radial strength, prevents undesirable rotations, uses minimal sensory input, is suitable for a wide variety of tools, and operates quickly.

Context of the End Effector Tool Changer within a Pick, Sort, and Place Robotic System

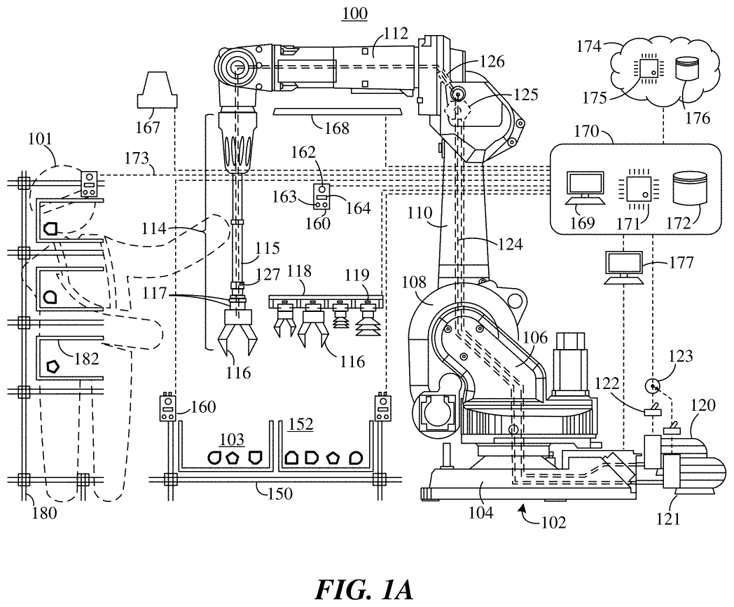

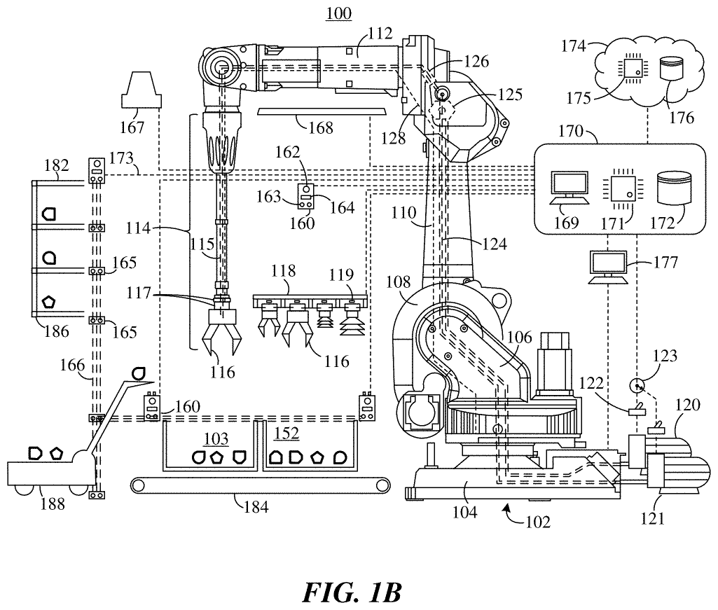

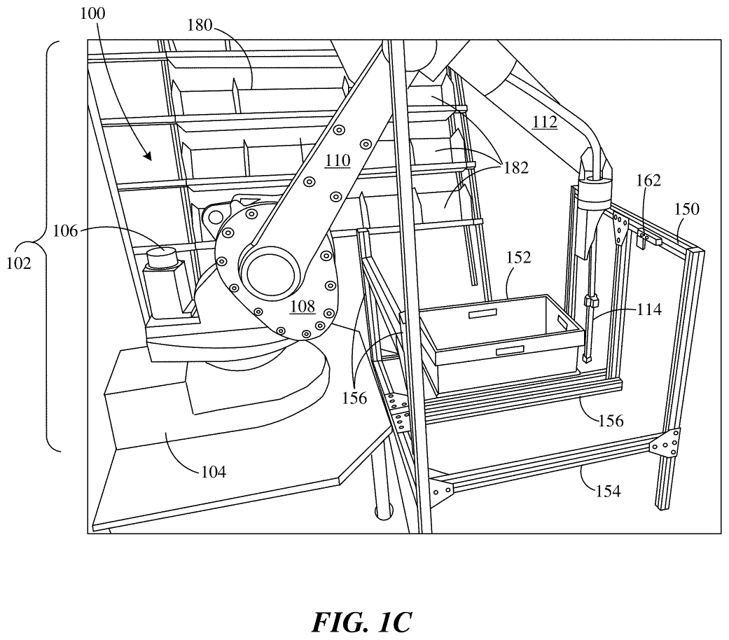

FIGS. 1A, 1B, and 1C show an exemplary pick, sort, and place robotic system 100 according to some embodiments of the present technology. Pick, sort, and place robotic system 100 is configured to pick, sort, and place a wide variety of objects 103 including novel objects that the system has not previously gripped, placed, or even seen.

The robotic system includes a robotic arm 102, various input and output components and structures such as a sorting stand 150 and a receptacle stand 180. An operator 101 may supervise or assist the robotic arm (see FIG. 1A). In some cases, the sorting stand 150 and/or receptacle stand 180 are replaced by or include a conveyor 184, a put wall 186, and/or an automated guided vehicle (AGV) 188, as shown in FIG. 1B. The robotic arm 102 grips objects 103 from tote 152 in sorting stand 150, identifies the gripped objects, and places the gripped objects at locations in receptacle stand 180 (e.g., bins 182). As shown in FIG. 1C, sorting stand 150 may include support structure 154, which is a system of metal support members bolted together. The side of support structure 154 opposite robotic arm 102 may include an opening allowing a tote (e.g., tote 152) or other receptacle to be inserted into sorting stand 150. Sorting stand 150 optionally includes base 156 for supporting receptacles.

Pick, sort, and place robotic system 100 also includes a control system 170 to monitor and manage robot motion. The control system provides instructions and/or command signals for moving (e.g., rotating, extending, retracting) the various components of robotic arm 102. The control system 170 comprises a processor 171, memory 172 (e.g., a non-transitory computer readable storage medium), data links 173, communications interfaces, and other components. The control system may also include an optional cloud component 174 with processors 175 and databases 176 accessible over a local or remote network (e.g., Internet). Pick, sort, and place robotic system 100 also includes a vision system with a vision processor 169, sensor devices 160, and other components. Each sensor device 160 may have one or more cameras 162, a variety of sensors 163 (e.g., image, depth, visible light, and/or infrared sensors), barcode readers 164, or other components. In some cases, cameras 162 capture image data that includes visible light data (e.g., RGB data) and/or depth information (e.g., how far objects in the image are from the camera). The captured image data is sent to the control system for processing. The vision system can have any number of sensors and cameras. Its components can be supported by any robotic, input/output component or structure, and be located in other locations.

Pick, sort, and place robotic system 100 also includes a motion controller 177. The vision processor 169 and motion controller 177 may be external or located within the control system 170. FIGS. 1A and 1B, for example, show an external motion controller 177 and a vision processor 169 that is located within the control system.

Pick, sort, and place robotic system 100 may also include a light curtain system comprising multiple sensors 165 generating a light curtain 166. Pick, sort, and place robotic system 100 may also include a LIDAR 167. The light curtain system and the LIDAR may be used either for safety purposes (e.g., monitor human movement around the robotic system) or for operations (e.g., detect the movement of objects or system components). Pick, sort, and place robotic system 100 may also include lighting devices 168 that can be dimmed depending on tote color or other environmental and operational factors.

Robotic arm 102 includes base 104 for mounting to a support surface (e.g., the floor or some other support structure). Frame 106 is rotatably connected to base 104. Lower arm 108 is rotatably connected to frame 110. Upper arm 112 is rotatably connected to lower arm 108. End effector 114 is rotatably connected to upper arm 112. End effector 114 includes one or more tools 116 as well as a spear 115. The end effector 114 and each tool 116 have tool changer 117 parts allowing various tools to be compatible with the end effector 114. A tool rack 118 is used for storing and accessing the various tools. Each tool slot on the tool rack 118 has a tool sensor 119 to indicate the presence or absence of a tool. FIGS. 1A and 1B show multiple gripping and suction tools such as claws and suction tools of various sizes. In the case of FIG. 1, gripper 116 is a suction gripper. Other grippers, such as gripping fingers or other types of suction grippers can also be used. In some cases, end effector 114 is compliant and/or multi-purpose.

Pick, sort, and place robotic system 100 may also include a vacuum source 120 (e.g., pump) or compressed air source 121 to provide the pressure necessary to use the tools, where vacuum denotes negative pressure and compressed air denotes positive pressure. Each source is controlled by a source switch 122 operable by the control system. A source selection switch 123 allows the control system to select the adequate source to operate the tool that is currently in use. A hose 124 runs through the robotic arm from the end effector to the sources. A valve 125 allows the control system to select a pressure source, or to connect the hose to the atmosphere (i.e., no positive or negative pressure applied). A pressure sensor 126 allows the control system to monitor the pressure level within the hose. A weight sensor 127 located on the end effector allows the control system to monitor the weight of the tool and its load (see FIG. 1A). A tool wire 128 running from the end effector to the base or to the frame of the robotic arm allows the control system to determine whether a tool is attached to the end effector.

All components of the control system 170 and vision system (e.g., cameras and sensors), are connected through data links 173. Furthermore, all components of the robotic system involved in motion or monitoring (e.g., motion controller 177, pump/selection switches 122/123, valve 125, pressure sensor 126, tool sensors 119, lighting devices 168) have data links 173 to the control system 170.

When the robotic system identifies a load to be picked up, it also determines a particular end effector tool among a selection of tools that is most appropriate for picking the load. However, in some cases, the robotic system may need to frequently change tools between objects. In such cases, there is a great need for a tool changer that operates automatically without human intervention. Current solutions include end effectors with magnetically coupled components that attach and detach seamlessly. However, some such devices are axially magnetized and have low radial strength. They may also rotate easily, making the system difficult to use and control. Moreover, magnetic couplings may not be sufficiently robust: tools may fall off due to collision or sudden movements. A new solution is to add mechanical pins to the magnetically coupled components in order to maintain the orientation of the two components and to add radial strength. The end effector tool changer described in this disclosure comprises a system designed for such a purpose.

Interaction between System Components

In one embodiment, the pick and place robotic system comprises: a robotic arm with an end effector configured to have an attached tool at its distal end; a tool changing device comprising a robotic arm attachment portion and a tool attachment portion; a tool rack comprising one or more tool plates and a plurality of tools; a vision system; and a control system comprising a processor, a non-transitory computer readable storage medium, and a plurality of communication interfaces; wherein the end effector comprises a robotic arm attachment portion of the tool changing device at its distal end, at least one tool comprises a tool attachment portion of the tool changing device at its proximal end, the robotic arm attachment portion is configured to attach to the tool attachment portion, at least one tool plate of the one or more tool plates comprises a tool slot, the pick and place robotic system is configured to carry out various processes. (See “End Effector Tool Changer in Action” section below.)

In some embodiments, each tool plate has exactly one tool slot. In other embodiments, a tool plate may have more than one tool slot. In one embodiment, the tool rack further comprises one or more sensors associated with a tool slot, wherein the one or more sensors are configured to indicate the presence of a tool in the tool slot.

In one embodiment, the control system receives data from each of the sensors on the tool rack and can determine, at any time, whether a given tool is located at its slot in the tool rack.

In yet another embodiment, the tool attachment portion further comprises a plurality of grooves, and the plurality of grooves spatially corresponds to a tool slot on a tool plate.

The grooves enable tools to slide into the tool rack and to be retrieved from the tool rack in a robust and timely manner.

In one embodiment, the pick and place robotic system further comprises a weight sensor at the distal end of the end effector, wherein the weight sensor is configured to measure the weight of an attached tool and its load (e.g., one or more objects).

A weight sensor may allow the control system to detect the presence or absence of a tool, the number of objects carried by it.

In one embodiment, the pick and place robotic system further comprises an electric circuit, wherein the electric circuit is configured to indicate the presence of a tool attached to the end effector. In one embodiment, the electric circuit is a tool wire.

A tool wire may be configured to be in contact with a tool when a tool is attached to the end effector so as to convey to the control system whether a tool is attached. In one embodiment, the presence of a tool is determined electrically (e.g., through detecting a change in wire impedance, current intensity, voltage, etc.).

In one embodiment, the tool wire is run from the tool, down the spear, to a proximal part of the robotic arm such as its base or its frame, where the information is conveyed to the control system through a data link.

In various embodiments, the tool changing device comprises a plurality of engagement mechanisms, wherein each engagement mechanism comprises a first part and a second part, wherein the first part and the second part of the engagement mechanism are selected from the group consisting of a pin and a pinhole, and wherein at least one of the first part and the second part is a pin, wherein the robotic arm attachment portion comprises a first plurality of magnets and a first plurality of first parts of the plurality of engagement mechanisms, wherein the tool attachment portion comprises a second plurality of magnets and a second plurality of second parts of the plurality of engagement mechanisms, wherein the first plurality of magnets spatially and magnetically corresponds to the second plurality of magnets, and wherein the first plurality of first parts of the plurality of engagement mechanisms spatially corresponds to the second plurality of second parts of the plurality of engagement mechanisms.

In some embodiments, the pick and place robotic system further comprises a plurality of input and output components, wherein at least one output component corresponds to an object type, and wherein the plurality of input and output components are selected from the group consisting of a sorting stand, a tote, a receptacle stand, a bin, a tote conveyor, an object conveyor, a put wall, an automated guided vehicle (AGV), and a shelf.

Objects may be classified by type. Object types may involve their shape (e.g., round vs. elongated objects), the material they are made of (e.g., plastic vs. metal objects), their color, or their nature (e.g., fruits vs. vegetables, apples vs. oranges). In one embodiment, objects having the same barcode or the same destination (e.g., shipping address, destination department in an office or plant, etc.) belong to the same object type. In one embodiment, objects belonging to the same order (e.g., they have the same order number) belong to the same object type. In one embodiment, each of the various output components (e.g., the bins in a sorting stand) are associated with distinct object types.

In some embodiments, the robotic arm and tool attachment portions further comprise a through-hole.

A through-hole is required to transmit vacuum or compressed air between an attached tool and its corresponding source pump. In one embodiment, the through-hole comprises a mechanical pass-through and an electrical pass-through.

In one embodiment, the pick and place robotic system further comprises a first hose, wherein the through-hole of the robotic arm attachment portion is connected to a distal end of the first hose.

In one embodiment, the pick and place robotic system further comprises a pressure sensor, wherein the pressure sensor is located on the first hose.

Data from the pressure sensor (e.g., a pressure reading) can indicate the presence or absence of an attached tool or a picked object.

In one embodiment, the pick and place robotic system further comprises a source pump, wherein the source pump is connected to the proximal end of the first hose, and the source pump is selected from the group consisting of a vacuum pump and a compressed air pump.

In systems operating using a single source pump, the first hose is the hose 124, represented in FIGS. 1A and 1B, connecting the tool directly to the source pump, wherein the term “connect” denotes the enabled flow of air, vacuum, or pressure.

In another embodiment, the pick and place robotic system further comprises a valve and one or more second hoses, wherein the valve connects the proximal end of the first hose to one valve output selected from the group consisting of the atmosphere and the one or more second hoses.

In one embodiment, the pick and place robotic system further comprises one or more source pumps, wherein at least one of the one or more second hoses connects a valve output to one of the one or more source pumps, at least one tool of the plurality of tools corresponds to one of the one or more source pumps, and a source pump of the one or more source pumps is selected from the group consisting of a vacuum pump and a compressed air pump.

In systems operating using more than one source pump (e.g., one vacuum pump and one compressed air pump), a valve is required to switch between pumps or to connect the tool to the atmosphere (i.e., disconnect from all pumps). In this case, the first hose is the distal segment of the hose 124 shown in FIGS. 1A and 1B. Furthermore, a second hose is required to connect the valve to each of the source pumps. The second hoses represent the proximal segments of the hose 124 shown in FIGS. 1A and 1B, connecting the valve to each of the source pumps.

In one embodiment, each source pump has a pump switch to activate it, and a pump selection switch is used by the control system to activate the required pump switch through data links or any other form of control signaling (e.g., an electrical ON/OFF signal).

In other embodiments, a fluid pump is used to control a tool. In this case, the through-hole, hoses, pressure sensors, and valve, are configured to operate with a fluid.

In one embodiment, the vision system comprises a vision processor, a plurality of vision communication interfaces, and one or more vision components selected from the group consisting of a camera, a barcode reader, a depth sensor, an infrared sensor, a light curtain system, and a LIDAR; and wherein at least one component of the vision system is connected to the vision processor through a data link, and the vision processor is connected to the control system through a data link

In one embodiment, the pick and place robotic system further comprises a lighting source, wherein the lighting source is configured to emit multiple light intensities.

In one embodiment, the control system controls robotic arm movements through a motion controller. In one embodiment, the motion controller also controls the valve.

In one embodiment, data from the pressure sensor, the weight sensor, the tool wire, the vision system sensors, the tool sensors, or any other component with a communication interface, is transmitted at regular time intervals to the control system (i.e., a data push). In another embodiment, such data is transmitted only upon request from the control system (i.e., a data pull).

In one embodiment, the tool wire is configured to provide the control system with information on the presence of an attached tool at the end effector continuously and instantaneously, through an electrical signal.

### Construction and Components of the End Effector Tool Changer

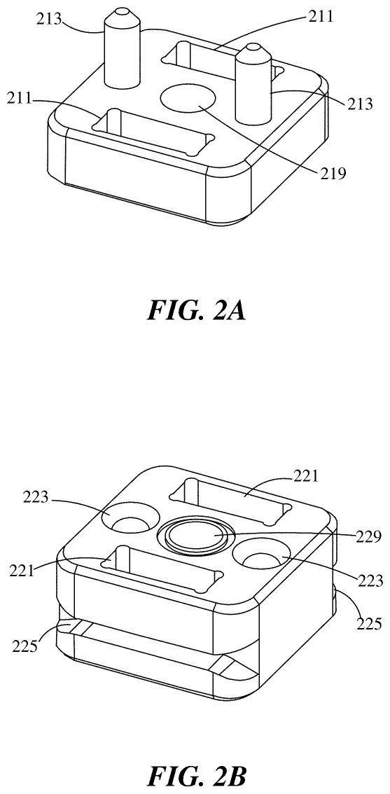

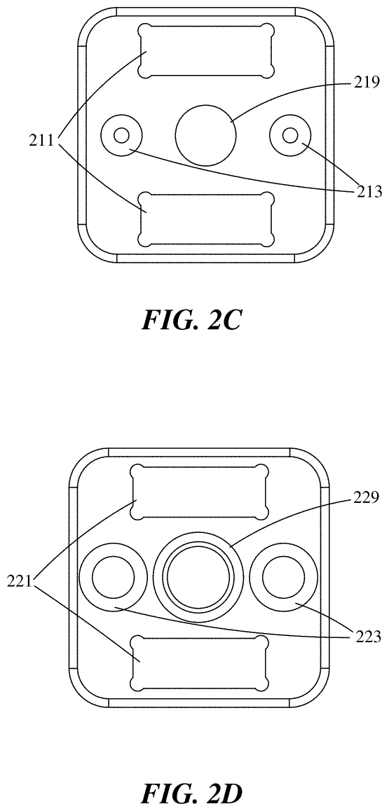

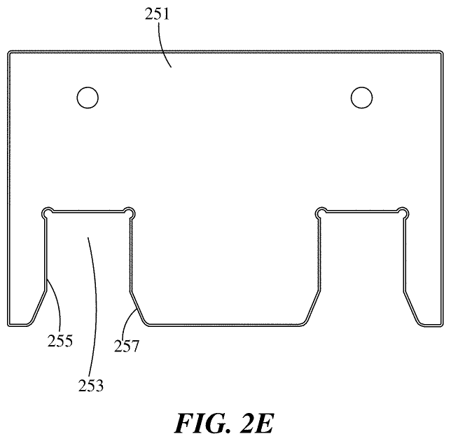

FIG. 2A shows an isometric view of an example arm attachment portion of an end effector tool changer for a pick, sort, and place robotic system, in accordance with one embodiment of the invention. The arm attachment portion is attached to the arm of the robotic system, and is designed to complement the tool attachment portion of the end effector tool changer described in reference to FIG. 2B where the faces of the two portions come into contact, so that the arm attachment portion and the tool attachment portion are mated or engaged. When the arm attachment portion is attached to the arm of the robotic system, the arm attachment portion and the tool attachment portion are mated or engaged, and the tool attachment portion is attached to a tool of the robotic system, the tool is said to be loaded onto the arm of the robotic system. Conversely, when the arm attachment portion is attached to the arm of the robotic system, the arm attachment portion and the tool attachment portion are not engaged, and the tool attachment portion is attached to a tool of the robotic system, the tool is said to be unloaded from the arm of the robotic system.

The arm attachment comprises a plurality of magnets 211 and a plurality of indicator pins 213. In some embodiments, the plurality of magnets 211 is a set of two magnets at opposite sides of the arm attachment. In some embodiments, the plurality of indicator pins 213 is a set of two indicator pins at opposite sides of the arm attachment. In some embodiments, the two magnets 211 are along one axis of the face of the arm attachment and the two indicator pins 213 are along the other axis of the face.

The indicator pins 213, when coupled with the tool attachment portion of the end effector tool changer described in reference to FIG. 2B, maintain the orientation of the end effector tool so that the system does not rotate. Furthermore, the indicator pins 213 provide radial strength, adding robustness to the system when it is mechanically disturbed, such as by bumping. In some embodiments, the indicator pins 213 are cylindrical. In some embodiments, the length of an indicator pin 213 is 3 to 5 times the diameter of the cylinder of the indicator pin; this geometry allows a strong seal to be maintained in the event of a radial load.

In some embodiments, the indicator pins 213 and the rest of the arm attachment portion are constructed together as a single piece, such as by molding, machining, or 3D printing. Some advantages of single-piece construction include the ease and speed of mass production and closer consistency within a batch of arm attachment portions.

The arm attachment portion optionally includes a through-hole 219 to access the various capabilities of a tool. In some embodiments, the through-hole 219 is capable of maintaining a vacuum for a vacuum-driven tool. In some embodiments, the through-hole 219 is capable of carrying compressed air for a compressed air-driven tool. In other embodiments, the through-hole 219 is capable of carrying mechanical or electrical connections between the arm and the tool, such as wires carrying signals.

FIG. 2B shows an isometric view of an example tool attachment portion of an end effector tool changer for a pick, sort, and place robotic system, in accordance with one embodiment of the invention. The tool attachment portion is attached to a gripper of the robotic system, and is designed to complement the arm attachment described in reference to FIG. 2A. The tool attachment portion comprises a plurality of magnets 221, a plurality of pinholes 223, and a plurality of grooves 225. The plurality of magnets 221 correspond, spatially and magnetically, with the plurality of magnets 211 of the arm attachment. In some embodiments, the plurality of magnets 221 is a set of two magnets at opposite sides of the arm attachment. The locations, orientations, and magnetic strengths of the plurality of magnets 211 and the plurality of magnets 221 provide sufficient force to hold a load on a tool, but still enable the robotic system to easily change tools by sliding off the tool attachment portion in accordance with methods described in this disclosure. If the magnetic force were too strong, for example, the robotic system would be unable to remove the tool attachment portion.

The plurality of pinholes 223 correspond spatially with the plurality of indicator pins 213 of the arm attachment. In some embodiments, the plurality of pinholes 223 is a set of two holes at opposite sides of the tool attachment portion. In some embodiments, the two magnets 221 are along one axis of the face of the tool attachment portion and the two pinholes 223 are along the other axis of the face. The plurality of grooves 225 are designed to complement the slots of the tool plate described in reference to FIG. 2E.

In some embodiments, there is error tolerance built into the size, shape, and locations of the indicator pins 213 and corresponding pinholes 223. This way, slight misalignments when adding a tool are tolerated. In some embodiments, the tips of the indicator pins 213 are tapered and/or the pinholes have wider lips to enable misalignments to be automatically corrected when the indicator pins 213 attempts to enter corresponding pinholes 223.

In some embodiments, the indicator pins 213 are manufactured from steel. In some embodiments, the housing for the arm attachment is manufactured from aluminum. In some embodiments, the housing for the tool attachment is manufactured from a softer material, such as a plastic material, e.g. polyoxymethylene (POM). Steel sliding on a softer material may support millions of attachments and separations with very little wear and tear.

As would be apparent to a person of ordinary skill in the art, there are various configurations of indicator pins and pinholes that are possible. For example, the two components may be switched, so that the tool attachment portion contains indicator pins and the arm attachment contains pinholes. Alternatively, each of the portions may contain both an indicator pin as well as a pinhole.

The tool attachment portion optionally includes a through-hole 229 to interact with a tool. The through-hole 229 may align with the through-hole 219 from the arm attachment portion to create a sealed channel for the tool when the arm attachment portion and the tool attachment portion come into contact with each other. An O-ring may be used to seal the interface between the through-hole 229 and the through-hole 219. The sealed channel may, in some embodiments, be capable of carrying a vacuum, compressed air, mechanical connections, or electrical connections. In some embodiments, the through-hole 229 and the through-hole 219 are centered on the faces of the tool attachment portion and the arm attachment portion, respectively.

FIG. 2C shows a top view from the contact side of an example arm attachment portion of an end effector tool changer for a pick, sort, and place robotic system, in accordance with one embodiment of the invention. As described in reference to FIG. 2A, the arm attachment portion comprises a plurality of magnets 211 and a plurality of indicator pins 213. The arm attachment portion optionally includes a through-hole 219 to access the vacuum channel of a tool.

FIG. 2D shows a top view from the contact side of an example tool attachment portion of an end effector tool changer for a pick, sort, and place robotic system, in accordance with one embodiment of the invention. As described in reference to FIG. 2B, the tool attachment portion comprises a plurality of magnets 221 and a plurality of pinholes 223. The tool attachment portion optionally includes a through-hole 229 to access the vacuum channel of a tool.

FIG. 2E shows a top view of an example tool plate 251 for a pick, sort, and place robotic system, in accordance with one embodiment of the invention. The tool plate 251 comprises a slot 253 whose dimensions correspond with the plurality of grooves 225 from the tool attachment portion in order to enable the tool plate 251 to firmly hold the tool attachment portion in the slot 253 via the edge 255. In some embodiments, the tool plate 251 further comprises a tapered slot 257 to allow for slight misalignments to be automatically corrected.

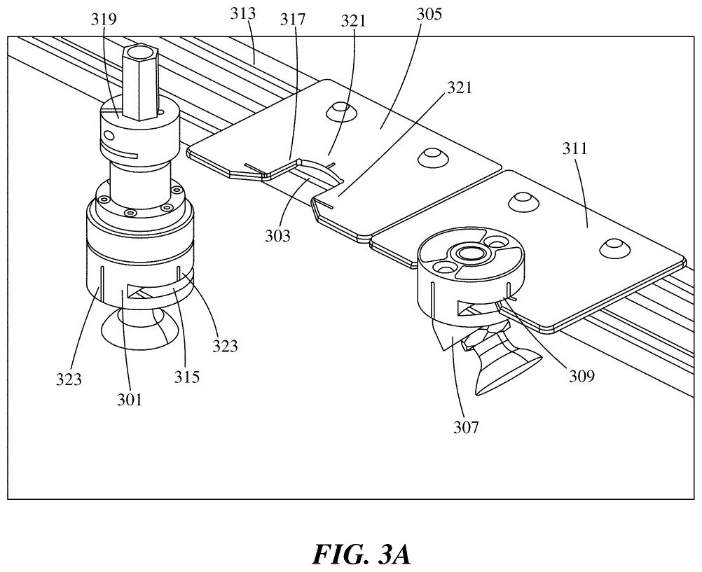

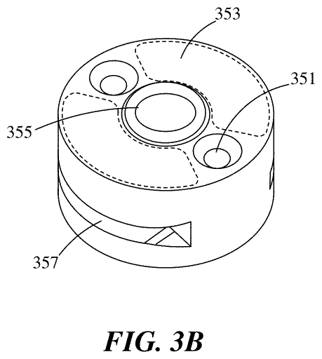

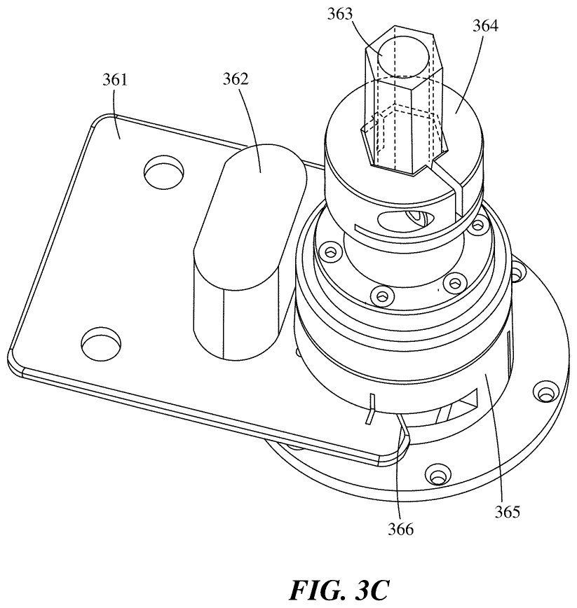

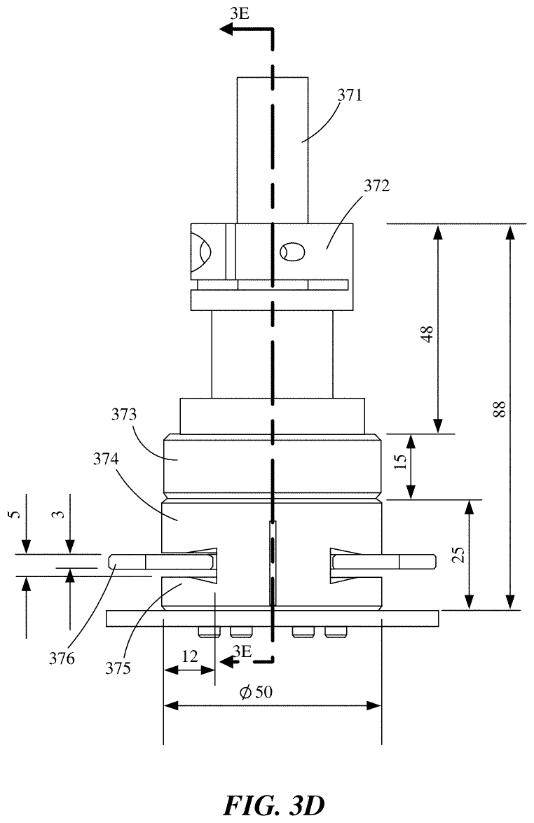

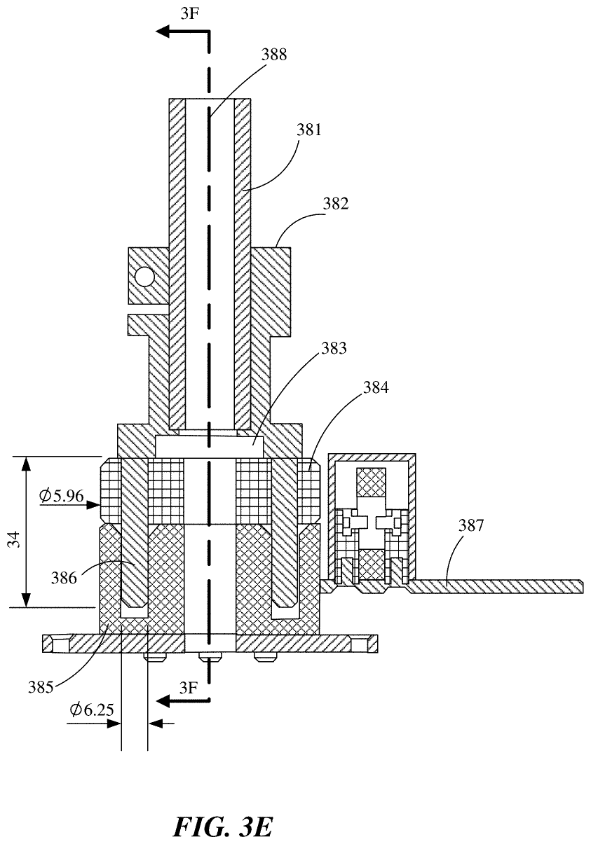

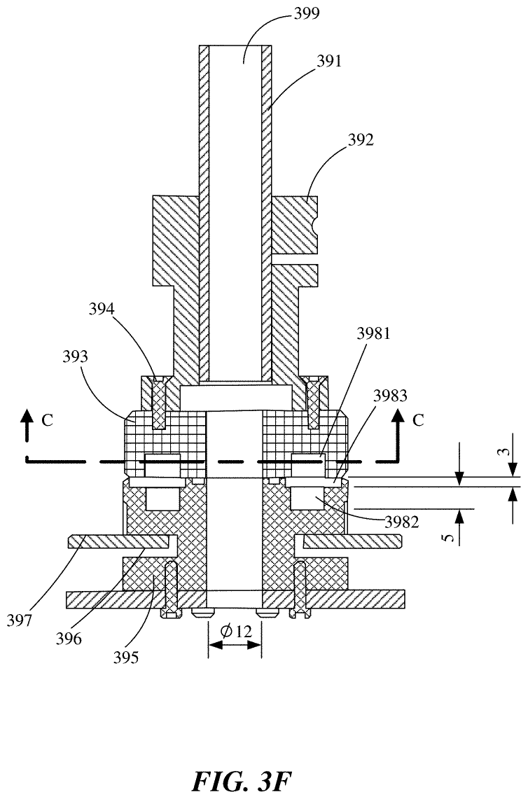

FIG. 3A shows an example end effector tool changer for a pick, sort, and place robotic system, in accordance with one embodiment of the invention. A tool rack 313 contains a plurality of tool plates associated with a plurality of slots. For example, a first tool plate 305 contains a first slot 303 and a second tool plate 311 contains a second slot 309. An arm attachment portion 319 is engaged with a first tool attachment portion 301, i.e. the tool associated with the first tool attachment portion 301 is loaded. In some embodiments, the first tool attachment portion 301 comprises tool alignment marks 323 and the first slot 303 comprises slot alignment marks 321. The set of slot alignments marks 321 and tool alignment marks 323 enables the system to determine the location of the first tool attachment portion 301 relative to the first tool plate 305. In some embodiments, the first tool attachment portion 301 comprises a plurality of grooves 315, which spatially correspond to the plurality of edges 317 of the first slot 303. FIG. 3A also shows a second tool attachment portion 307 held in the second slot 309.

FIG. 3B shows an isometric view of an example tool attachment portion of an end effector tool changer for a pick, sort, and place robotic system, in accordance with one embodiment of the invention. The tool attachment portion comprises a plurality of pinholes 351, a plurality of magnets 353, a through-hole 355, and a plurality of grooves 357.

FIG. 3C shows an example end effector tool changer for a pick, sort, and place robotic system, in accordance with one embodiment of the invention. A tool plate 361 comprises a tool sensor 362, which is configured to detect the presence of a tool attachment portion 365 in the slot 366 corresponding to the tool plate 361. In some embodiments, the arm attachment portion is engaged with the tool attachment portion 365, and the arm attachment portion is attached to a spear 363 via shaft adapter 364.

FIGS. 3D, 3E, and 3F show example end effector tool changers with exemplary dimensions for a pick, sort, and place robotic system, in accordance with one embodiment of the invention. The numerical dimensions indicate distances in millimeters.

FIG. 3D shows an example end effector tool changer with exemplary dimensions for a pick, sort, and place robotic system, in accordance with one embodiment of the invention, as viewed externally. A spear 371 is attached to an arm attachment portion 373 via a shaft adapter 372. The arm attachment portion 373 is engaged with a tool attachment portion 374, which comprises a plurality of grooves 375. The plurality of grooves 375 corresponds spatially with slot 376 of a tool rack.

FIG. 3E shows an example end effector tool changer with exemplary dimensions for a pick, sort, and place robotic system, in accordance with one embodiment of the invention, as a cutaway view cut along the pins and pinholes. A spear 381 with a through-hole 388 is attached to an arm attachment portion 384 via a shaft adapter 382. An O-ring 383 seals the connection between the through-hole 388 of the spear with the corresponding through-hole of the arm attachment portion 384. The arm attachment portion 384 is engaged with a tool attachment portion 385 via a plurality of pins 386. A slot 387 of a tool rack holds the tool attachment portion 385.

FIG. 3F shows an example end effector tool changer with exemplary dimensions for a pick, sort, and place robotic system, in accordance with one embodiment of the invention, as a cutaway view cut along the magnets. A spear 391 with a through-hole 399 is attached to an arm attachment portion 393 via a shaft adapter 322 and screws 394. The arm attachment portion 393 comprises a plurality of magnets 3981, and a tool attachment portion 395 comprises a plurality of magnets 3982. When the arm attachment portion 393 is engaged with the tool attachment portion 395, the plurality of magnets 3981 and the plurality of magnets 3982 are separated by a plurality of spacers 3983, which in some embodiments is a component of the tool attachment portion 395. The plurality of spacers are designed to physically protect the plurality of magnets 3982 of the tool attachment portion 395 from dangers such as being knocked by external objects, which may weaken the magnetic field strength of the plurality of magnets 3982. A slot 397 of a tool rack holds the tool attachment portion 395 via a plurality of grooves 396.

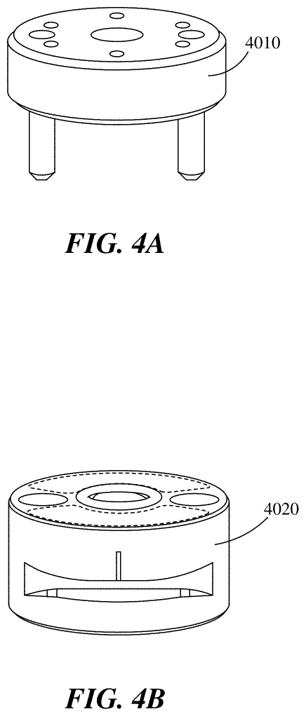

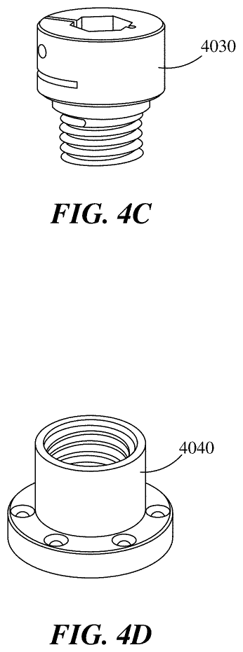

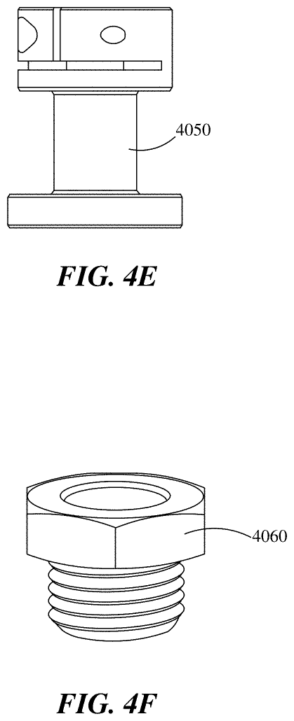

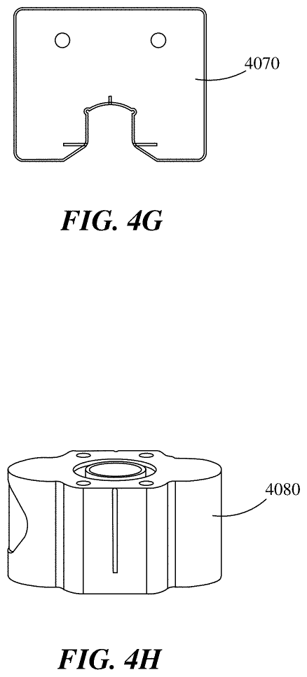

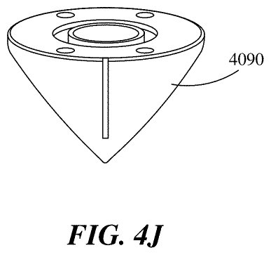

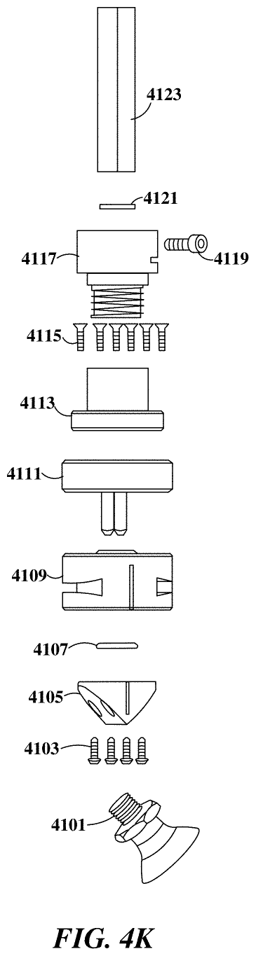

FIGS. 4A, 4B, 4C, 4D, 4E, 4F, 4G, 4H, and 4J show example components of an end effector tool changer for a pick, sort, and place robotic system, in accordance with one embodiment of the invention. In particular, FIG. 4A shows an upper part 4010, FIG. 4B shows a lower part 4020, FIG. 4C shows a hex shaft adapter A 4030, FIG. 4D shows a hex shaft adapter B 4040, FIG. 4E shows a round shaft adapter 4050, FIG. 4F shows a fitting 4060, FIG. 4G shows a tool plate 4070, FIG. 4H shows an offset adapter 4080, and FIG. 4J shows an angle adapter 4090.

In some embodiments, the upper part 4010 is the arm attachment portion referenced in FIG. 2A. In some embodiments, the lower part 4020 is the tool attachment portion referenced in FIG. 2B.

FIG. 4K shows an exploded view of various example components of an end effector tool changer for a pick, sort, and place robotic system, in accordance with one embodiment of the invention. In some embodiments, component 4101 is a gripper, component 4103 is a plurality of thread screws, component 4105 is an angle adapter 4090, component 4107 is an O-ring, component 4109 is a lower part 4020, component 4111 is an upper part 4010, component 4113 is a hex shaft adapter A 4030, component 4115 is a plurality of flat screws, component 4117 is round shaft adapter 4050, component 4119 is a socket screw, component 4121 is a flat O-ring, and component 4123 is a shaft.

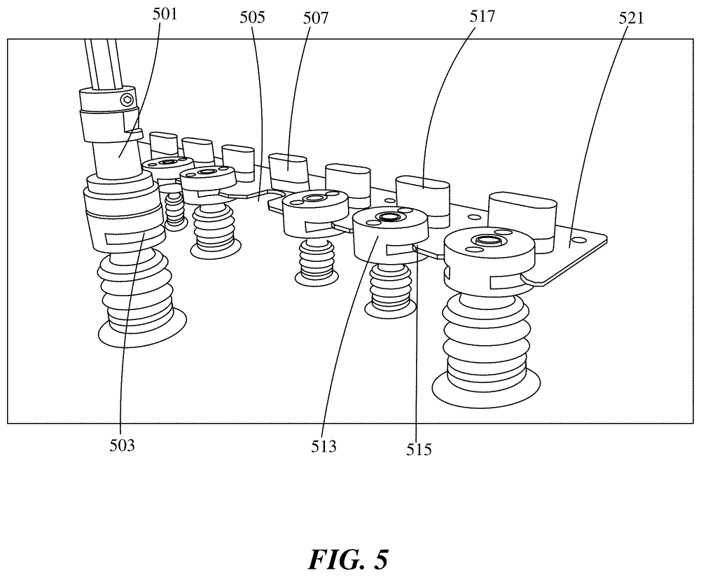

FIG. 5 shows an example end effector tool changer for a pick, sort, and place robotic system, in accordance with one embodiment of the invention. A tool rack 521 comprises a plurality of tool slots, including a first tool slot 505 and a second tool slot 515, and a plurality of tool sensors, including a first tool sensor 507 and a second tool sensor 517. The first tool sensor 507 is configured to detect the presence of a tool attachment portion in the first tool slot 505. As shown in FIG. 5, the first tool slot 505 is empty, so the first tool sensor 507 indicates the absence of a tool attachment portion. If an arm attachment portion 501 engaged with a first tool attachment portion 503 were to approach the first tool slot 505 and unload the first tool attachment portion 503, the first tool sensor 507 would then indicate the presence of the first tool attachment portion 503 in the first tool slot 505. A second tool attachment portion 513 is in the second tool slot 515. As a result, the second tool sensor 517 indicates the presence of the second tool attachment portion 513.

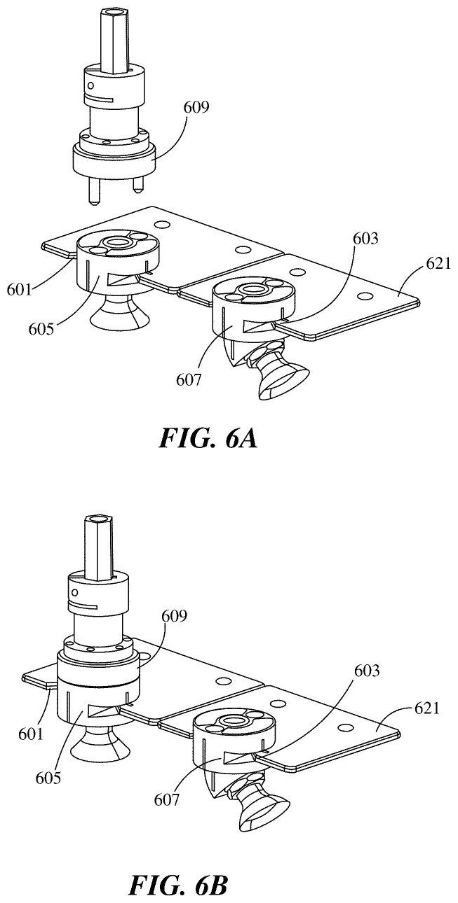

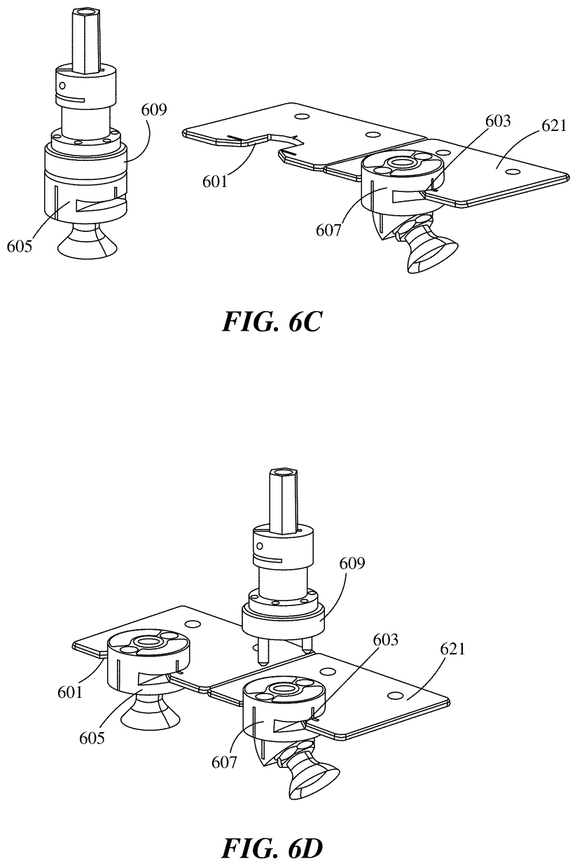

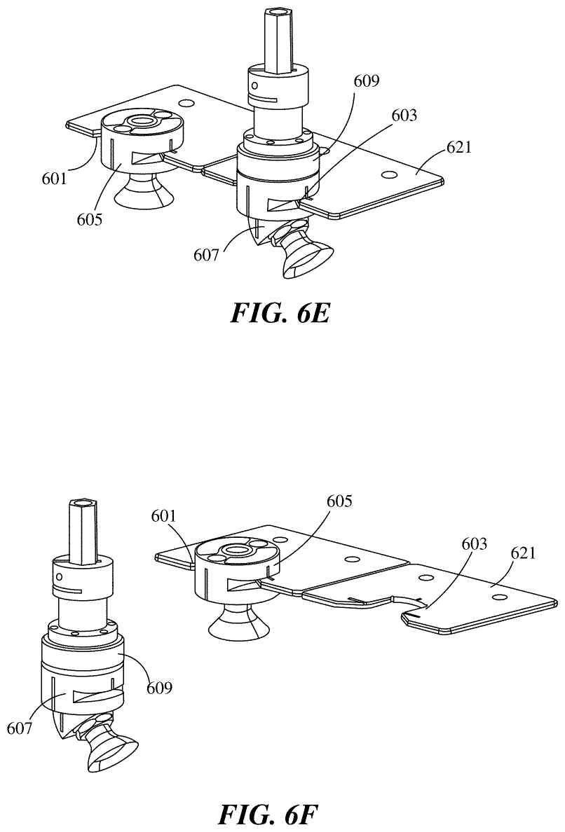

FIGS. 6A, 6B, 6C, 6D, 6E, and 6F show various example states of an end effector tool changer for a pick, sort, and place robotic system, in accordance with one embodiment of the invention. In these example states, an arm attachment portion 609 is attached to an arm of a pick, sort, and place robotic system. The arm attachment portion 609 is accessible to a tool rack 621 comprising a plurality of tool plates and a plurality of slots, including a first slot 601 and a second slot 603. The tool rack 621 is able to hold a plurality of tool attachment portions, including a first tool attachment portion 605 and a second tool attachment portion 607. In some embodiments, the first tool attachment portion 605 is attached to a first gripper of the robotic system. In some embodiments, the second tool attachment portion 607 is attached to a second gripper of the robotic system.

FIG. 6A shows an example state of an end effector tool changer, wherein the first tool attachment portion 605 and the second tool attachment portion 607 are held in the first slot 601 and the second slot 603, respectively, the arm attachment portion 609 is engaged with neither the first tool attachment portion 605 nor the second tool attachment portion 607, and the arm attachment portion 609 is ready to be engaged with the first tool attachment portion 605.

FIG. 6B shows an example state of an end effector tool changer, wherein the first tool attachment portion 605 and the second tool attachment portion 607 are held in the first slot 601 and the second slot 603, respectively, and the arm attachment portion 609 is engaged with the first tool attachment portion 605.

FIG. 6C shows an example state of an end effector tool changer, wherein the second tool attachment portion 607 is held in the second slot 603, the first slot 601 is empty, and the arm attachment portion 609 is engaged with the first tool attachment portion 605 away from the tool rack 621.

FIG. 6D shows an example state of an end effector tool changer, wherein the first tool attachment portion 605 and the second tool attachment portion 607 are held in the first slot 601 and the second slot 603, respectively, the arm attachment portion 609 is engaged with neither the first tool attachment portion 605 nor the second tool attachment portion 607, and the arm attachment portion 609 is ready to be engaged with the second tool attachment portion 607.

FIG. 6E shows an example state of an end effector tool changer, wherein the first tool attachment portion 605 and the second tool attachment portion 607 are held in the first slot 601 and the second slot 603, respectively, and the arm attachment portion 609 is engaged with the second tool attachment portion 607.

FIG. 6F shows an example state of an end effector tool changer, wherein the first tool attachment portion 605 is held in the first slot 601, the second slot 603 is empty, and the arm attachment portion 609 is engaged with the second tool attachment portion 607 away from the tool rack 621.

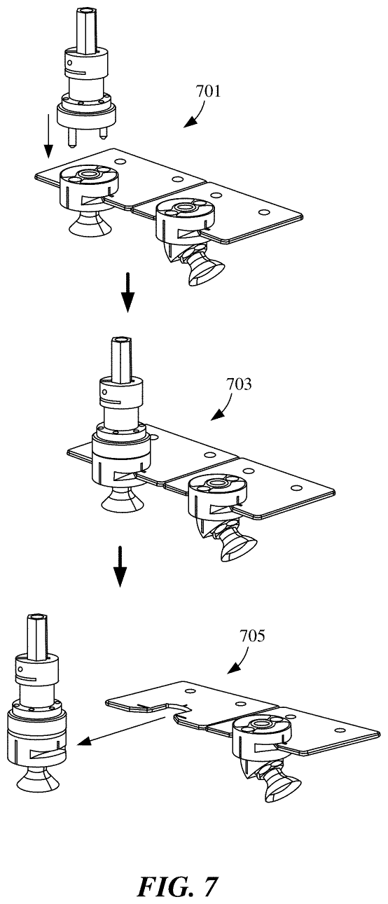

FIGS. 7, 8, and 9 show example state flows for various actions of an end effector tool changer for a pick, sort, and place robotic system, in accordance with one embodiment of the invention. In these example state flows, the states correspond to the example states depicted in FIGS. 6A, 6B, 6C, 6D, 6E, and 6F.

FIG. 7 shows an example state flow for tool retrieval for an end effector tool changer for a pick, sort, and place robotic system, in accordance with one embodiment of the invention. In some embodiments, tool retrieval is used by the system in order to load a tool onto an arm of the system. The system begins in state 701, which is depicted in FIG. 6A. Next, the system retrieves the first tool attachment portion 605 by engaging the arm attachment portion 609 with the first tool attachment portion 605, which places the system in state 703, as depicted in FIG. 6B. Finally, the system moves the first tool attachment portion 605 out of the first slot 601 and away from the tool rack 621, which places the system in state 705, as depicted in FIG. 6C. The first tool attachment portion 605 is now retrieved and ready for use.

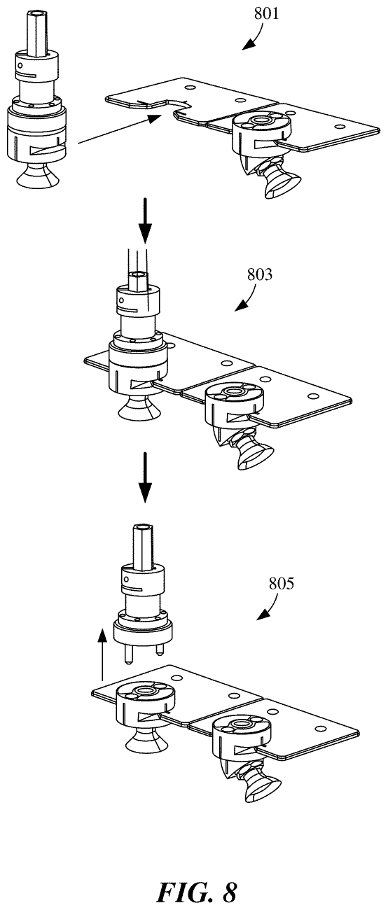

FIG. 8 shows an example state flow for tool storage for an end effector tool changer for a pick, sort, and place robotic system, in accordance with one embodiment of the invention. Tool storage is the reverse of tool retrieval. In some embodiments, tool storage is used by the system in order to unload a tool from an arm of the system. The system begins in state 801, which is depicted in FIG. 6C. Next, the system stores the first tool attachment portion 605 by moving the first tool attachment portion 605 toward the tool rack 621 and into the first slot 601, which places the system in state 803, as depicted in FIG. 6B. Finally, the system disengages the arm attachment portion 609 from the first tool attachment portion 605, which places the system in state 805, as depicted in FIG. 6A. The first tool attachment portion 605 is now stored in the tool rack 621.

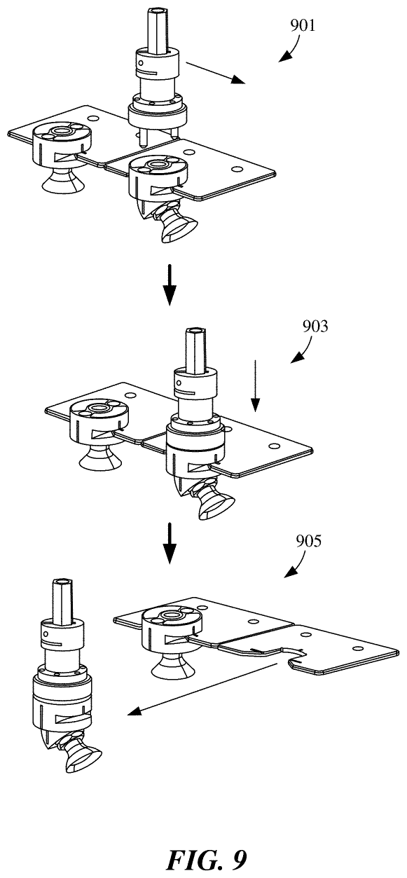

FIG. 9 shows an example state flow for tool switching for an end effector tool changer for a pick, sort, and place robotic system, in accordance with one embodiment of the invention. The system begins in a state depicted in FIG. 6A, where the system had previously disengaged the arm attachment portion 609 from the first tool attachment portion 605. Next, the system moves the arm attachment portion 609 near the second tool attachment portion 607 so that the arm attachment portion 609 is ready to be engaged with the second tool attachment portion 607, which places the system in state 901, as depicted in FIG. 6D. Next, the system switches to the second tool attachment portion 607 by engaging the arm attachment portion 609 with the second tool attachment portion 607, which places the system in state 903, as depicted in FIG. 6E. Finally, the system moves the second tool attachment portion 607 out of the second slot 603 and away from the tool rack 621, which places the system in state 905, as depicted in FIG. 6F. The second tool attachment portion 607 is now retrieved and ready for use.

### End Effector Tool Changer in Action

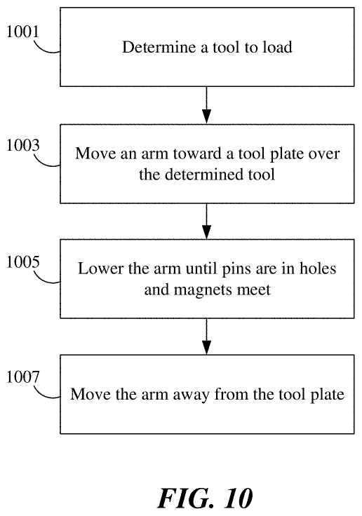

FIG. 10 shows an illustrative flow diagram for loading an end effector tool for a pick, sort, and place robotic system, in accordance with one embodiment of the invention. FIG. 10 begins (step 1001) by determining a tool to load. In step 1003, the system moves the arm toward the tool plate over the determined tool from step 1001. In step 1005, the system lowers the arm until the indicator pins are in the corresponding pinholes and the corresponding magnets meet. In step 1007, the system moves the arm away from the tool plate and is ready for use.

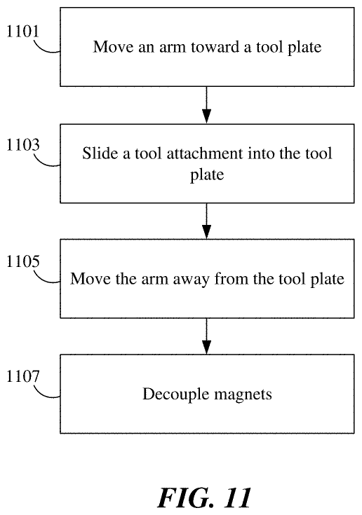

FIG. 11 shows an illustrative flow diagram for unloading an end effector tool for a pick, sort, and place robotic system, in accordance with one embodiment of the invention. FIG. 11 begins (step 1101) by moving the arm toward the tool plate. In step 1103, the system slides the tool attachment into the tool plate, where the grooves of the tool attachment portion slide into the slot of the tool plate. In step 1105, the system moves the arm away from the tool plate. In step 1107, the magnets are decoupled from each other and the arm is free of the tool.

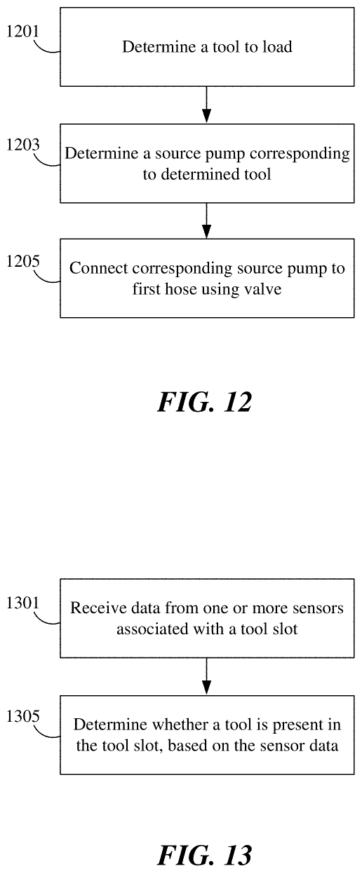

FIG. 12 shows an illustrative flow diagram for connecting a source pump corresponding to an end effector tool for a pick, sort, and place robotic system, in accordance with one embodiment of the invention. FIG. 12 begins (step 1201) by determining a tool to load. In step 1203, the system determines a source pump corresponding to the end effector tool determined from step 1201. In step 1205, the system connects the corresponding source pump to the first hose using the valve (see FIGS. 1A and 1B).

In one embodiment, the control system sends a signal to the valve to switch from one valve output to another through a data link. In one embodiment, the plurality of available tools are categorized by their corresponding source pump. For example, suction tools may require a compressed air pump whereas gripping tools may require a vacuum pump.

FIG. 13 shows an illustrative flow diagram for determining whether an end effector tool is present at a given tool slot on the tool rack using the tool sensors, in accordance with one embodiment of the invention. In step 1301, the pick, sort, and place robotic system receives data from one or more sensors associated with a tool slot. In step 1305, the system determines whether a tool is present in the tool slot, based on the sensor data received from step 1301.

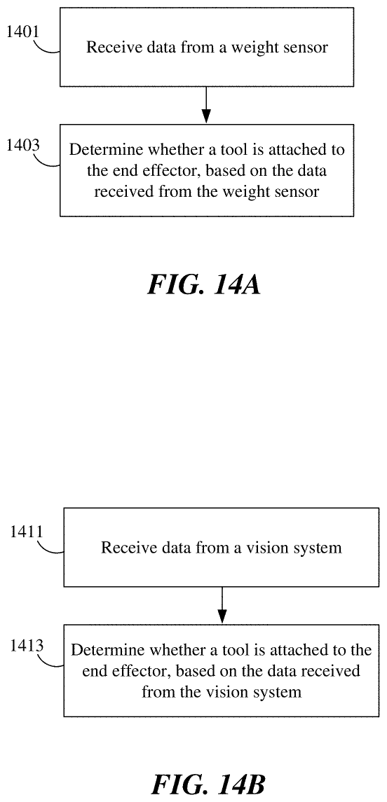

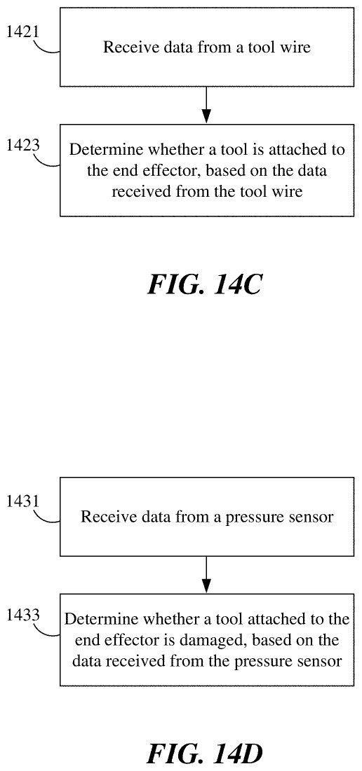

FIG. 14A shows an illustrative flow diagram for determining whether a tool is present at the end effector using a weight sensor, for a pick, sort, and place robotic system, in accordance with one embodiment of the invention. FIG. 14A begins (step 1401) by receiving data from a weight sensor. In step 1403, the system determines whether a tool is attached to the end effector, based on the data received from the weight sensor from step 1401.

In one embodiment of step 1403, the system compares a weight reading from the weight sensor with a known weight of an attached tool, wherein a weight reading close to the known weight indicates that there is a tool attached to the end effector.

FIG. 14B shows an illustrative flow diagram for determining whether a tool is present at the end effector using a vision system, for a pick, sort, and place robotic system, in accordance with one embodiment of the invention. FIG. 14B begins (step 1411) by receiving data from a vision system. In step 1413, the system determines whether a tool is attached to the end effector, based on the data received from the vision system from step 1411.

FIG. 14C shows an illustrative flow diagram for determining whether a tool is present at the end effector using a tool wire, for a pick, sort, and place robotic system, in accordance with one embodiment of the invention. FIG. 14C begins (step 1421) by receiving data from a tool wire. In step 1423, the system determines whether a tool is attached to the end effector, based on the data received from the tool wire from step 1421. In other embodiments, an electric circuit is configured to indicate the presence of a tool attached to the end effector via the illustrative flow diagram shown in FIG. 14C.

FIG. 14D shows an illustrative flow diagram for determining whether an attached tool is damaged using a pressure sensor, for a pick, sort, and place robotic system, in accordance with one embodiment of the invention. FIG. 14D begins (step 1431) by receiving data from a pressure sensor. In step 1433, the system determines whether a tool attached to the end effector is damaged, based on the data received from the pressure sensor from step 1431.

In one embodiment of step 1433, the system compares a pressure reading from the pressure sensor with atmospheric pressure, wherein a pressure reading close to the atmospheric pressure indicates that the attached tool is damaged. In another embodiment, a pressure reading close to the atmospheric pressure indicates that there is no tool attached to the end effector.

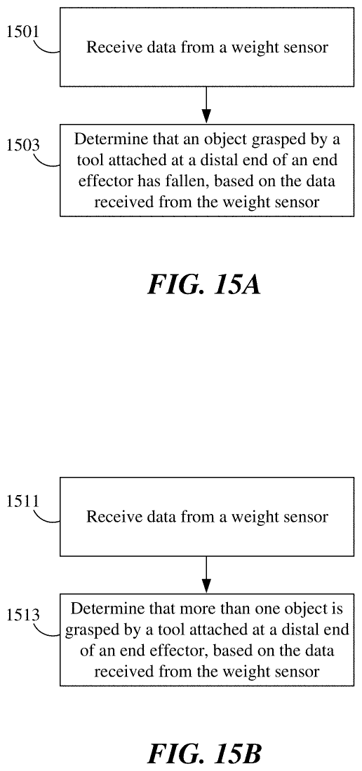

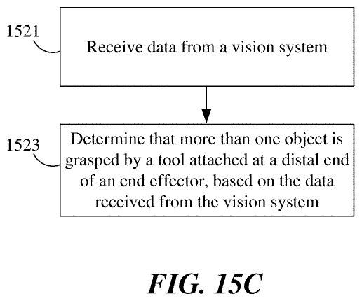

FIG. 15A shows an illustrative flow diagram for a pick, sort, and place robotic system to detect, using a weight sensor, that an object grasped by an attached tool has fallen, in accordance with one embodiment of the invention. FIG. 15 begins (step 1501) by receiving data from a weight sensor. In step 1503, the system determines that an object grasped by a tool attached at a distal end of an end effector has fallen, based on the data received from the weight sensor from step 1501.

FIG. 15B shows an illustrative flow diagram for a pick, sort, and place robotic system to detect, using a weight sensor, that more than one object is grasped by an attached tool, in accordance with one embodiment of the invention. FIG. 15B begins (step 1511) by receiving data from a weight sensor. In step 1513, the system determines that more than one object is grasped by a tool attached at a distal end of an end effector, based on the data received from the weight sensor from step 1511.

In some embodiments, the illustrative flow diagram shown in FIG. 15B is used to detect a multiple picking, after which the system rejects the pick. In other embodiments, an application may prefer to pick multiple objects simultaneously, which is faster. In such embodiments, the weight sensor detects the total weight of the objects picked, and may reject a multiple pick only if the total weight of the objects picked exceeds a predetermined threshold.

FIG. 15C shows an illustrative flow diagram for a pick, sort, and place robotic system to detect, using a vision system, that more than one object is grasped by an attached tool, in accordance with one embodiment of the invention. FIG. 15C begins (step 1521) by receiving data from a vision system. In step 1523, the system determines that more than one object is grasped by a tool attached at a distal end of an end effector, based on the data received from the vision system from step 1521.

In some embodiments, the illustrative flow diagram shown in FIG. 15C is used to detect a multiple picking, after which the system rejects the pick. In other embodiments, an application may prefer to pick multiple objects simultaneously, which is faster. In such embodiments, the vision system detects the total number or approximate total volume of the objects picked, and may reject a multiple pick only if the total number or approximate total volume of the objects picked exceeds a predetermined threshold.

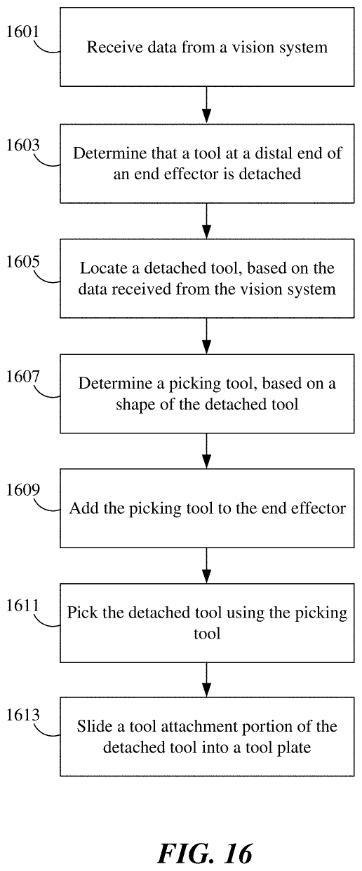

FIG. 16 shows an illustrative flow diagram for replacing a detached tool into the tool rack of a pick, sort, and place robotic system, in accordance with one embodiment of the invention. FIG. 16 begins (step 1601) by receiving data from a vision system. In step 1603, the system determines that a tool at a distal end of an end effector is detached. In step 1605, the system locates the detached tool, based on the data received from step 1601. In step 1607, the system determines a picking tool, based on a shape of the detached tool. In step 1609, the system adds the picking tool to the end effector. In step 1611, the system picks the detached tool using the picking tool. In step 1613, the system slides a tool attachment portion of the detached tool into a tool plate, thus replacing the detached tool into the tool rack.

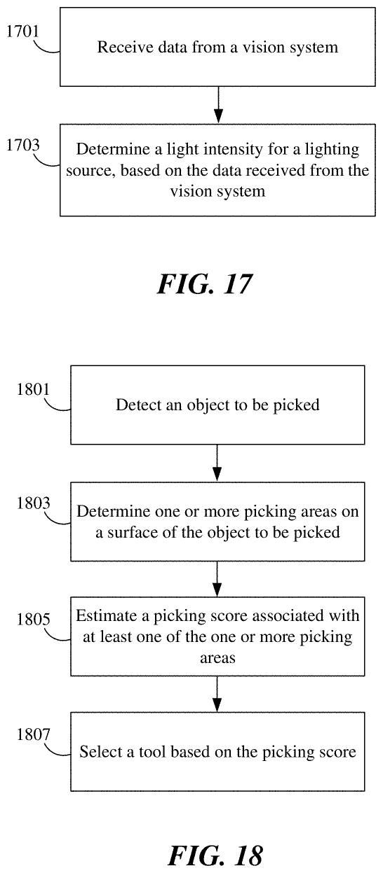

FIG. 17 shows an illustrative flow diagram for adjusting the lighting intensity to improve object or tool vision for a pick, sort, and place robotic system, in accordance with one embodiment of the invention. FIG. 17 begins (step 1701) by receiving data from a vision system. In step 1703, the system determines a light intensity for a lighting source, based on the data received from step 1701.

In one embodiment, the data received from the vision system is used to determine the visibility of objects in the input components. In one embodiment, low object visibility triggers the system to increase a light intensity for a lighting source.

FIG. 18 shows an illustrative flow diagram for a pick, sort, and place robotic system to select a tool to pick an object, in accordance with one embodiment of the invention. FIG. 18 begins (step 1801) by detecting an object to be picked. In step 1803, the system determines one or more picking areas on a surface of the object to be picked. In step 1805, the system estimates a picking score associated with at least one of the one or more picking areas. In step 1807, the system selects a tool based on the picking score estimated in step 1805.

In another embodiment, the system may begin by detecting a plurality of objects to be picked and determining one or more picking areas on a surface of each of the plurality of objects to be picked. In another embodiment, the system may estimate a picking score associated with each determined picking area and select one picking area per detected object based on the estimated picking scores. In another embodiment, the system may prioritize picking objects having picking areas associated with the highest picking score. In yet another embodiment, the system may further compute a group picking score for a group of detected objects (e.g., objects belonging to the same type) based on the picking scores associated with a picking area of each of the objects. In another embodiment, the system may prioritize picking object groups (e.g., types) having picking areas associated with the highest group picking score.

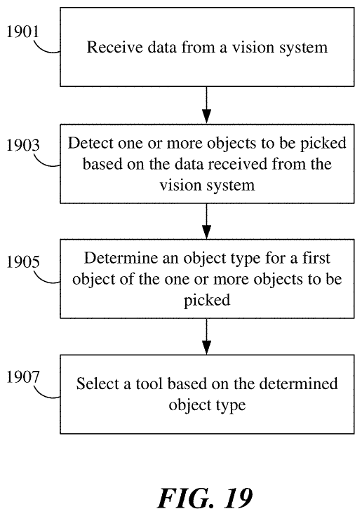

FIG. 19 shows an illustrative flow diagram for a pick, sort, and place robotic system to select a next tool based on detected object types, in accordance with one embodiment of the invention. FIG. 19 begins (step 1901) by receiving data from a vision system. In step 1903, the system detects one or more objects to be picked based on the data received from step 1901. In step 1905, the system determines an object type for a first object of the one or more objects to be picked. In step 1907, the system selects a tool based on the determined object type.

In one embodiment, the system may group detected objects (e.g., according to their object type) and select a tool based on the size of a detected object group.

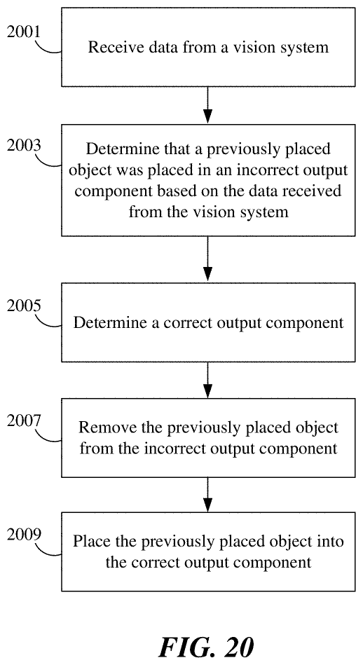

FIG. 20 shows an illustrative flow diagram for a pick, sort, and place robotic system to replace an object previously placed in an incorrect output component, in accordance with one embodiment of the invention. FIG. 20 begins (step 2001) by receiving data from a vision system. In step 2005, the system determines a correct output component. In step 2007, the system removes the previously placed object from the incorrect output component. In step 2009, the system places the previously placed object into the correct output component.

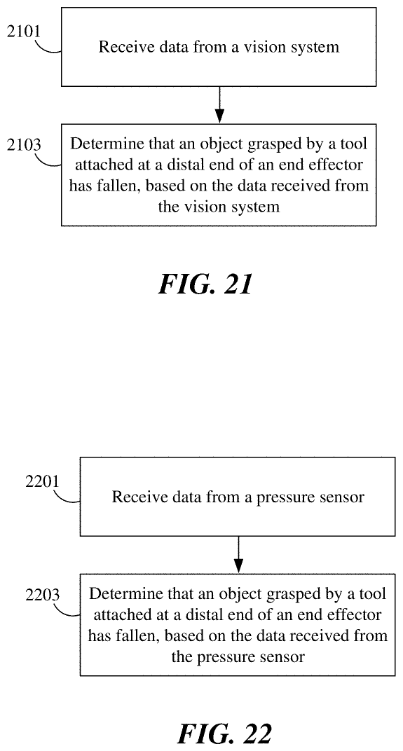

FIG. 21 shows an illustrative flow diagram for a pick, sort, and place robotic system to detect an object fall using a vision system, in accordance with one embodiment of the invention. FIG. 21 begins (step 2101) by receiving data from a vision system. In step 2103, the system determines that an object grasped by a tool attached at a distal end of an end effector has fallen, based on the data received from step 2101.

FIG. 22 shows an illustrative flow diagram for a pick, sort, and place robotic system to detect an object fall using a pressure sensor, in accordance with one embodiment of the invention. FIG. 22 begins (step 2201) by receiving data from a pressure sensor. In step 2203, the system determines that an object grasped by a tool attached at a distal end of an end effector has fallen, based on the data received from step 2201.

In one embodiment of step 2203, the system compares the pressure reading with atmospheric pressure, wherein a pressure reading close to the atmospheric pressure indicates that there is no object attached to the end effector tool.

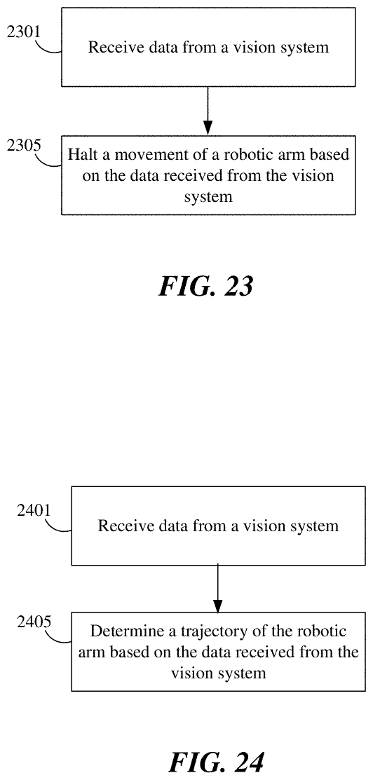

FIG. 23 shows an illustrative flow diagram for a pick, sort, and place robotic system to halt the movement of a robotic arm based on input from the vision system, in accordance with one embodiment of the invention. FIG. 23 begins (step 2301) by receiving data from a vision system. In step 2305, the system halts a movement of the robotic arm based on the data received from the vision system from step 2301.

In one embodiment, arm movement is halted when an operator or an unrecognized object obstructs a trajectory of the robotic arm. In another embodiment, the vision system comprises a light curtain that is used to detect obstructions to robotic arm movement. In one embodiment, the light curtain is used as a safety measure to protect operators.

FIG. 24 shows an illustrative flow diagram for a pick, sort, and place robotic system to determine a trajectory of the robotic arm based on data received from the vision system, in accordance with one embodiment of the invention. FIG. 24 begins (step 2401) by receiving data from a vision system. In step 2403, the system determines a trajectory of the robotic arm based on the data received in step 2401 from the vision system.

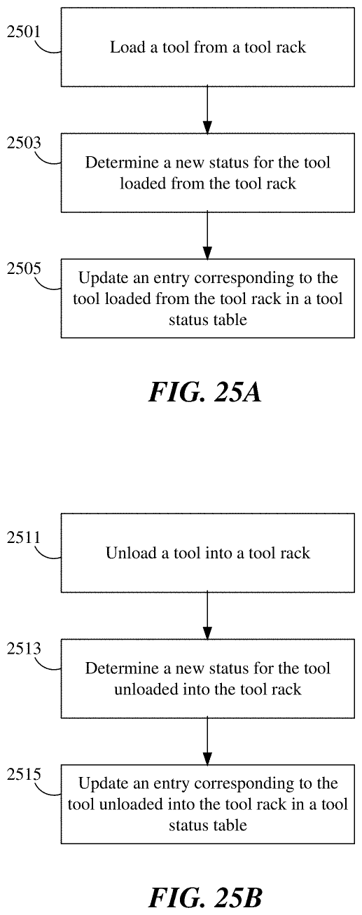

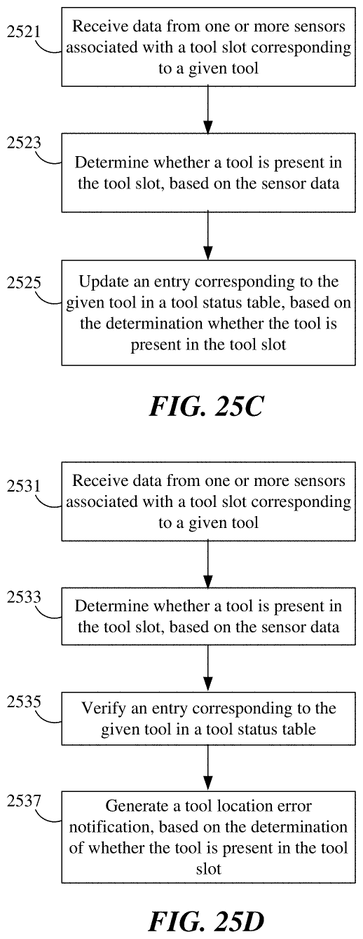

FIGS. 25A, 25B, 25C, and 25D show illustrative flow diagrams for a pick, sort, and place robotic system to maintain a tool status table, in accordance with one embodiment of the invention.

FIG. 25A shows an illustrative flow diagram for a pick, sort, and place robotic system to update a tool status table following a loading operation, in accordance with one embodiment of the invention. FIG. 25A begins (step 2501) by loading a tool from a tool rack. In step 2503, the system determines a new status for the tool loaded from the tool rack. In step 2505, the system updates an entry corresponding to the tool loaded from the tool rack in a tool status table.

FIG. 25B shows an illustrative flow diagram for a pick, sort, and place robotic system to update a tool status table following an unloading operation, in accordance with one embodiment of the invention. FIG. 25B begins (step 2511) by unloading a tool into a tool rack. In step 2513, the system determines a new status for the tool unloaded into the tool rack. In step 2515, the system updates an entry corresponding to the tool unloaded into the tool rack in a tool status table.

FIG. 25C shows an illustrative flow diagram for a pick, sort, and place robotic system to update a tool status table based on sensor data, in accordance with one embodiment of the invention. FIG. 25C begins (step 2521) by receiving data from one or more sensors associated with a tool slot corresponding to a given tool. In step 2523, the system determines whether a tool is present in the tool slot, based on the sensor data from step 2521. In step 2525, the system updates an entry corresponding to the given tool in a tool status table, based on the determination from step 2523 whether the tool is present in the tool slot.

FIG. 25D shows an illustrative flow diagram for a pick, sort, and place robotic system to verify a tool status table and generate a notification based on sensor data, in accordance with one embodiment of the invention. FIG. 25D begins (step 2531) by receiving data from one or more sensors associated with a tool slot corresponding to a given tool. In step 2533, the system determines whether a tool is present in the tool slot, based on the sensor data from step 2531. In step 2535, the system verifies an entry corresponding to the given tool in a tool status table. In step 2537, the system generates a tool location error notification, based on the determination of whether the tool is present in the tool slot from step 2533.

In various embodiments, the system combines data from one or more of the vision system, the weight sensor, the tool wire, and the pressure sensor, to determine whether a tool is attached at the end effector, whether an object was successfully picked by the robotic arm, whether an object was released or dropped by the robotic arm, whether more than one object is grasped by an attached tool, whether a tool is damaged, and whether a tool has fallen or become detached.

Implementation using Computer Program Products, Methods, and Computing Entities

The present invention may be implemented in a combination of hardware and/or software. An illustrative hardware and software operational environment for implementing one embodiment of the present invention is now described.

Embodiments of the present disclosure may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

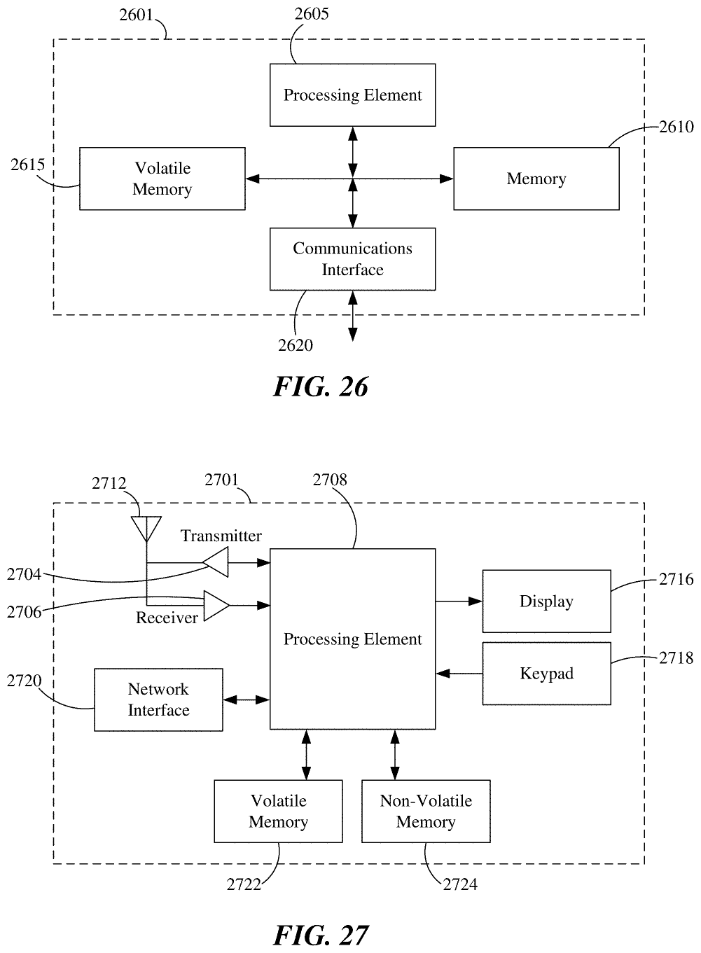

An exemplary embodiment of the present disclosure may include one or more servers (management computing entities), one or more networks, and one or more clients (user computing entities). Each of these components, entities, devices, systems, and similar words used herein interchangeably may be in direct or indirect communication with, for example, one another over the same or different wired or wireless networks. Additionally, while FIGS. 26 and 27 illustrate the various system entities as separate, standalone entities, the various embodiments are not limited to this particular architecture.

### Exemplary Management Computing Entity

FIG. 26 provides a schematic of a server (management computing entity) 2601 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 2601 may also include one or more communications interfaces 2620 for communicating with various computing entities, such as by communicating data, content, information, and/or similar terms used herein interchangeably that can be transmitted, received, operated on, processed, displayed, stored, and/or the like.

As shown in FIG. 26, in one embodiment, the management computing entity 2601 may include or be in communication with one or more processing elements 2605 (also referred to as processors, processing circuitry, and/or similar terms used herein interchangeably) that communicate with other elements within the management computing entity 2601 via a bus, for example. As will be understood, the processing element 2605 may be embodied in a number of different ways. For example, the processing element 2605 may be embodied as one or more complex programmable logic devices (CPLDs), microprocessors, multi-core processors, coprocessing entities, application-specific instruction-set processors (ASIPs), microcontrollers, and/or controllers. Further, the processing element 2605 may be embodied as one or more other processing devices or circuitry. The term circuitry may refer to an entirely hardware embodiment or a combination of hardware and computer program products. Thus, the processing element 2605 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 2605 may be configured for a particular use or configured to execute instructions stored in volatile or non-volatile media or otherwise accessible to the processing element 2605. As such, whether configured by hardware or computer program products, or by a combination thereof, the processing element 2605 may be capable of performing steps or operations according to embodiments of the present disclosure when configured accordingly.

In one embodiment, the management computing entity 2601 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 2610, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 2601 may further include or be in communication with volatile media (also referred to as volatile storage, memory, memory storage, memory circuitry and/or similar terms used herein interchangeably). In one embodiment, the volatile storage or memory may also include one or more volatile storage or memory media 2615, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 2605. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 2601 with the assistance of the processing element 2605 and operating system.

As indicated, in one embodiment, the management computing entity 2601 may also include one or more communications interfaces 2620 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 2601 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 2601 may include or be in communication with one or more input elements, such as a keyboard input, a mouse input, a touch screen/display input, motion input, movement input, audio input, pointing device input, joystick input, keypad input, and/or the like. The management computing entity 2601 may also include or be in communication with one or more output elements (not shown), such as audio output, video output, screen/display output, motion output, movement output, and/or the like.

As will be appreciated, one or more of the components of the management computing entity 2601 may be located remotely from other management computing entity 2601 components, such as in a distributed system. Furthermore, one or more of the components may be combined and additional components performing functions described herein may be included in the management computing entity 2601. Thus, the management computing entity 2601 can be adapted to accommodate a variety of needs and circumstances. As will be recognized, these architectures and descriptions are provided for exemplary purposes only and are not limiting to the various embodiments.

### Exemplary User Computing Entity

A user may be an individual, a company, an organization, an entity, a department within an organization, a representative of an organization and/or person, and/or the like. FIG. 27 provides an illustrative schematic representative of a client (user computing entity) 2701 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles, watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 2701 can be operated by various parties. As shown in FIG. 27, the user computing entity 2701 can include an antenna 2712, a transmitter 2704 (e.g., radio), a receiver 2706 (e.g., radio), and a processing element 2708 (e.g., CPLDs, microprocessors, multi-core processors, coprocessing entities, ASIPs, microcontrollers, and/or controllers) that provides signals to and receives signals from the transmitter 2704 and receiver 2706, respectively.

The signals provided to and received from the transmitter 2704 and the receiver 2706, respectively, may include signalling information in accordance with air interface standards of applicable wireless systems. In this regard, the user computing entity 2701 may be capable of operating with one or more air interface standards, communication protocols, modulation types, and access types. More particularly, the user computing entity 2701 may operate in accordance with any of a number of wireless communication standards and protocols, such as those described above with regard to the management computing entity 2601. In a particular embodiment, the user computing entity 2701 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 2701 may operate in accordance with multiple wired communication standards and protocols, such as those described above with regard to the management computing entity 2601 via a network interface 2720.

Via these communication standards and protocols, the user computing entity 2701 can communicate with various other entities using concepts such as Unstructured Supplementary Service Data (USSD), Short Message Service (SMS), Multimedia Messaging Service (MMS), Dual-Tone Multi-Frequency Signalling (DTMF), and/or Subscriber Identity Module Dialer (SIM dialer). The user computing entity 2701 can also download changes, add-ons, and updates, for instance, to its firmware, software (e.g., including executable instructions, applications, program modules), and operating system.

According to one embodiment, the user computing entity 2701 may include location determining aspects, devices, modules, functionalities, and/or similar words used herein interchangeably. For example, the user computing entity 2701 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 2701 position in connection with a variety of other systems, including cellular towers, Wi-Fi access points, and/or the like. Similarly, the user computing entity 2701 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 2701 may also comprise a user interface (that can include a display 2716 coupled to a processing element 2708) and/or a user input interface (coupled to a processing element 2708). For example, the user interface may be a user application, browser, user interface, and/or similar words used herein interchangeably executing on and/or accessible via the user computing entity 2701 to interact with and/or cause display of information from the management computing entity 2601, as described herein. The user input interface can comprise any of a number of devices or interfaces allowing the user computing entity 2701 to receive data, such as a keypad 2718 (hard or soft), a touch display, voice/speech or motion interfaces, or other input device. In embodiments including a keypad 2718, the keypad 2718 can include (or cause display of) the conventional numeric (0-9) and related keys (#, *), and other keys used for operating the user computing entity 2701 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 2701 can also include volatile storage or memory 2722 and/or non-volatile storage or memory 2724, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 2701. As indicated, this may include a user application that is resident on the entity or accessible through a browser or other user interface for communicating with the management computing entity 2601 and/or various other computing entities.

In another embodiment, the user computing entity 2701 may include one or more components or functionality that are the same or similar to those of the management computing entity 2601, as described in greater detail above. As will be recognized, these architectures and descriptions are provided for exemplary purposes only and are not limiting to the various embodiments.

### Additional Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module or sequence of instructions referred to as “computer program(s)” or “computer code(s).” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks, which include Compact Disk Read-Only Memory (CD ROMS), Digital Versatile Disks (DVDs), etc., as well as digital and analog communication media.

One of ordinary skill in the art knows that the use cases, structures, schematics, and flow diagrams may be performed in other orders or combinations, but the inventive concept of the present invention remains without departing from the broader scope of the invention. Every embodiment may be unique, and methods/steps may be either shortened or lengthened, overlapped with the other activities, postponed, delayed, and continued after a time gap to practice the methods of the present invention.

### Conclusions

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

Although the present invention has been described with reference to specific exemplary embodiments, it will be evident that the various modification and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

What is claimed is:

1. An end effector tool changer device for a pick and place robotic system, comprising:
a plurality of engagement mechanisms,
wherein each engagement mechanism comprises a first part and a second part,
wherein the first part and the second part of the engagement mechanism are selected from the group consisting of a pin and a pinhole, and wherein at least one of the first part and the second part is a pin;
a robotic arm attachment portion, comprising a first plurality of magnets and a first plurality of first parts of the plurality of engagement mechanisms;
a tool attachment portion, comprising a second plurality of magnets, a second plurality of second parts of the plurality of engagement mechanisms, and a plurality of grooves,
wherein the first plurality of magnets spatially and magnetically corresponds to the second plurality of magnets, and
wherein the first plurality of first parts of the plurality of engagement mechanisms spatially corresponds to the second plurality of second parts of the plurality of engagement mechanisms; and
a tool plate comprising a slot, wherein dimensions of the slot correspond to the plurality of grooves on the tool attachment portion.

2. The end effector tool changer device of claim 1, wherein the pin is selected from the group consisting of an indicator pin and a lateral pin.

3. The end effector tool changer device of claim 1, wherein the robotic arm attachment portion and the plurality of first parts of the plurality of engagement mechanisms form a single piece.

4. The end effector tool changer device of claim 1, wherein the tool attachment portion and the plurality of second parts of the plurality of engagement mechanisms form a single piece.

5. The end effector tool changer device of claim 1, wherein one or more of the plurality of grooves are beveled.

6. The end effector tool changer device of claim 1, wherein the plurality of grooves is a pair of grooves.

7. The end effector tool changer device of claim 1, wherein the distance between a magnet of the first plurality of magnets and a corresponding magnet of the second plurality of magnets when the robotic arm attachment and the tool attachment portions are engaged, was selected to generate a strength of the magnetic force between the magnet of the first plurality of magnets and the corresponding magnet of the second plurality of magnets.

8. The end effector tool changer device of claim 1, wherein the volumes of a magnet of the first plurality of magnets and a corresponding magnet of the second plurality of magnets were selected to generate a strength of the magnetic force between the magnet of the first plurality of magnets and the corresponding magnet of the second plurality of magnets.

9. The end effector tool changer device of claim 1, wherein the grades of a magnet of the first plurality of magnets and a corresponding magnet of the second plurality of magnets were selected to generate a strength of the magnetic force between the magnet of the first plurality of magnets and the corresponding magnet of the second plurality of magnets.

10. The end effector tool changer device of claim 1, wherein the slot is tapered.

11. The end effector tool changer device of claim 1, wherein the robotic arm and tool attachment portions each further comprise a through-hole.

12. The end effector tool changer device of claim 11, wherein the through-hole in the robotic arm attachment portion is adjacent to an O-ring.

13. The end effector tool changer device of claim 1, wherein an engagement mechanism of the plurality of engagement mechanisms comprises a pin with a tapered tip.

14. The end effector tool changer device of claim 1, wherein an engagement mechanism of the plurality of engagement mechanisms comprises a beveled pinhole.

15. A pick and place robotic system, the system comprising:
a robotic arm with an end effector configured to have an attached tool at its distal end;
a tool changing device comprising a robotic arm attachment portion and a tool attachment portion;
a tool rack comprising one or more tool plates and a plurality of tools;
a vision system; and
a control system comprising a processor, a non-transitory computer readable storage medium, and a plurality of communication interfaces,
wherein:
the end effector comprises a robotic arm attachment portion of the tool changing device at its distal end,
at least one tool comprises a tool attachment portion of the tool changing device at its proximal end,
the robotic arm attachment portion is configured to attach to the tool attachment portion,
at least one tool plate of the one or more tool plates comprises a tool slot, wherein dimensions of the tool slot correspond to a plurality of grooves on the tool attachment portion;
the pick and place robotic system is configured to load a tool from the tool rack to the end effector, and
the pick and place robotic system is configured to unload a tool from the end effector to the tool rack.

16. The pick and place robotic system of claim 15, wherein the tool changing device comprises a plurality of engagement mechanisms,
wherein each engagement mechanism comprises a first part and a second part,
wherein the first part and the second part of the engagement mechanism are selected from the group consisting of a pin and a pinhole, and wherein at least one of the first part and the second part is a pin,
wherein the robotic arm attachment portion comprises a first plurality of magnets and a first plurality of first parts of the plurality of engagement mechanisms,
wherein the tool attachment portion comprises a second plurality of magnets and a second plurality of second parts of the plurality of engagement mechanisms,
wherein the first plurality of magnets spatially and magnetically corresponds to the second plurality of magnets, and
wherein the first plurality of first parts of the plurality of engagement mechanisms spatially corresponds to the second plurality of second parts of the plurality of engagement mechanisms.

17. The pick and place robotic system of claim 15, wherein:
the tool attachment portion further comprises a plurality of grooves, and
the plurality of grooves spatially corresponds to a tool slot on a tool plate.

18. The pick and place robotic system of claim 15, wherein the tool rack further comprises:
one or more sensors associated with a tool slot, wherein the one or more sensors are configured to indicate the presence of a tool in the tool slot.

19. The pick and place robotic system of claim 15, further comprising a weight sensor at the distal end of the end effector, wherein the weight sensor is configured to measure the weight of a tool and a load of the tool.

20. The pick and place robotic system of claim 15, further comprising an electric circuit, wherein the electric circuit is configured to indicate the presence of a tool attached to the end effector.

21. The pick and place robotic system of claim 15, wherein:
the robotic arm and tool attachment portions further comprise a through-hole.

22. The pick and place robotic system of claim 15, wherein:
the vision system comprises a vision processor, a plurality of vision communication interfaces, and one or more vision components selected from the group consisting of a camera, a barcode reader, a depth sensor, an infrared sensor, a light curtain system, and a LIDAR; and wherein:
at least one component of the vision system is connected to the vision processor through a data link, and
the vision processor is connected to the control system through a data link.

23. The pick and place robotic system of claim 22, further comprising a lighting source, wherein:
the lighting source is configured to emit multiple light intensities.

24. The pick and place robotic system of claim 15, wherein the non-transitory computer readable storage medium has program instructions embodied therein, the program instructions executable by the processor to cause the processor to:
determine a selected tool to load;
move the robotic arm toward the tool rack over the selected tool;
lower the robotic arm until a plurality of pins are in a plurality of corresponding pinholes and a plurality of magnets on the arm attachment portion meets a plurality of corresponding magnets on the tool attachment portion; and
move the arm away from the tool rack.

25. The pick and place robotic system of claim 15, wherein the non-transitory computer readable storage medium has program instructions embodied therein, the program instructions executable by the processor to cause the processor to:
receive data from the vision system; and
determine that more than one object is grasped by a tool attached at the distal end of the end effector, based on the data received from the vision system.

26. The pick and place robotic system of claim 15, wherein the non-transitory computer readable storage medium has program instructions embodied therein, the program instructions executable by the processor to cause the processor to:
receive data from a pressure sensor; and
determine that an object grasped by a tool attached at the distal end of the end effector has fallen, based on the data received from the pressure sensor.

27. The pick and place robotic system of claim 15, wherein the non-transitory computer readable storage medium has program instructions embodied therein, the program instructions executable by the processor to cause the processor to:
receive data from the vision system;
detect an object to be picked based on the data received from the vision system; and
determine one or more picking areas on the surface of the object to be picked.

28. The pick and place robotic system of claim 27, wherein the program instructions executable by the processor further cause the processor to:
estimate a picking score associated with at least one of the one or more picking areas, for at least one of the plurality of tools, based on the data received from the vision system, wherein:
the picking score indicates a likelihood that the robotic arm successfully picks the object.

29. The pick and place robotic system of claim 15, wherein the non-transitory computer readable storage medium has program instructions embodied therein, the program instructions executable by the processor to cause the processor to:
receive data from the vision system; and
determine that a previously placed object was placed in an incorrect output component based on the data received from the vision system,
wherein the incorrect output component is an output component that does not correspond to the object type of the previously placed object.

30. The pick and place robotic system of claim 29, wherein the program instructions executable by the processor further cause the processor to:
determine a correct output component;
remove the previously placed object from the incorrect output component; and
place the previously placed object into the correct output component, wherein the correct output component is an output component that corresponds to the object type of the previously placed object.
